(19) United States
(12) Patent Application Publication
(10) Pub. No.: US 2026/0199860 A1
(43) Pub. Date: Jul. 16, 2026

(54) SYSTEM AND METHODS CONFIGURED TO ENABLE IMPROVED/OPTIMISED CONTROL OF A HYDROCARBON PYROLYSIS PROCESS

(71) Applicant: Hazer Group Limited, Perth, Western Australia (AU)

(72) Inventors: Andrew CORNEJO, Perth, Western Australia (AU); Tim FORBES, Perth, Western Australia (AU); Matthew WARD, Perth, Western Australia (AU)

(73) Assignee: Hazer Group Limited, Perth, Western Australia (AU)

(21) Appl. No.: 19/135,185

(22) PCT Filed: Dec. 8, 2023
(86) PCT No.: PCT/AU2023/051270

§ 371 Date: Jun. 3, 2025

(30) Foreign Application Priority Data
Dec. 9, 2022 (AU) 2022903775

(51) Int. Cl. B01J 8/00; B01J 8/18; B01J 8/24; C01B 3/26; C01B 3/28

(52) U.S. Cl. CPC B01J 8/001; B01J 8/003; B01J 8/0035; B01J 8/1827; B01J 8/1836; B01J 8/24; C01B 3/26; C01B 3/28; B01J 2208/00061; B01J 2208/00088; B01J 2208/00398; B01J 2208/00415; B01J 2208/00539; B01J 2208/00628; B01J 2208/00663; B01J 2208/00672; B01J 2208/00752; B01J 2208/00805; C01B 2203/0272; C01B 2203/0277; C01B 2203/085; C01B 2203/1241; C01B 2203/1623; C01B 2203/169

(57) ABSTRACT

The present invention relates, in various embodiments, to system and methods configured to enable improved/optimised control of a hydrocarbon pyrolysis process. Embodiments have been developed for implementation in a context of hydrocarbon gas pyrolysis systems in which there is a reactor subsystem having a reactor chamber in which a hydrocarbon gas is decomposed in presence of a conductive particulate material.

### RELATED APPLICATION

The present application claims convention priority from Australian Provisional Patent Application No. 2022903775, filed on 9 Dec. 2022. The content of AU'775 is incorporated by reference herein in its entirety.

### FIELD OF THE INVENTION

The present invention relates, in various embodiments, to system and methods configured to enable improved/optimised control of a hydrocarbon pyrolysis process. Embodiments have been developed for implementation in a context of hydrocarbon gas pyrolysis systems in which there is a reactor subsystem having a reactor chamber in which a hydrocarbon gas is decomposed in presence of a conductive particulate material.

### BACKGROUND OF THE INVENTION

Any discussion of the background art throughout the specification should in no way be considered as an admission that such art is widely known or forms part of common general knowledge in the field.

Methane pyrolysis (also referred to as natural gas pyrolysis or methane decomposition) refers to a process by which methane is converted into solid carbon and hydrogen. This yields layered benefits, for example in relation to intrinsic values of both solid carbon and hydrogen, and additionally within the context of initiatives for the mitigation of atmospheric carbon dioxide.

Hydrogen has many commercial uses, such as a clean and environmentally friendly alternative fuel for vehicles. Carbon, or more particularly graphite, is considered a key material in the emerging green technology market. It has been shown to be useful in energy storage/batteries, electrical conduction devices, catalyst supports, lubrication additives and modern electronics equipment. All references to carbon within this patent relates to the graphitic form of carbon, therefore these terms are used interchangeably throughout.

Conventional methods of producing hydrogen from fossil fuels, for example, Steam Methane Reforming (SMR), however produce carbon dioxide (natural gas steam reforming and coal gasification) which is harmful to the environment.

Solid carbon, or more particularly graphite, is considered a key material in the emerging green technology market. It has been shown to be useful in energy storage, electric vehicles, photovoltaics and modern electronics equipment.

Natural gas can be catalytically cracked into both hydrogen gas and solid carbon according to Equation (1).

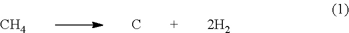

In such a process, the carbon deposits onto the surface of the catalyst and hydrogen gas evolves. There are a wide number of known catalysts for the process, including precious metals and carbon-based catalysts.

Whilst the above process is known, it has not been exploited commercially for a number of economic reasons. This primarily relates to the underlying catalyst costs, both in the initial supply, as well as costs in recycling and regenerating the catalyst. The vast majority of researchers in this area have utilised expensive and complex supported catalysts which, despite their high catalyst activity and product yield, result in extremely high catalyst turnover costs. These costs are a significant barrier to commercialising the use of such catalysts. There is a significant need for new and improved processes and catalysts for the catalytic conversion of hydrocarbons to hydrogen and a solid carbon which are stable and commercially valuable.

The present applicant has been named on numerous patent publications, for example WO 2016/154666, WO 2017/031529 and WO 2018/170543, each of which are incorporated herein by cross reference. Amongst other things, these patent publications describe technologies for methane pyrolysis using a fluidised bed reactor and iron containing catalyst (synthetic and naturally occurring). The present inventors have recognised improvements to such technologies.

It is an object of the present invention to overcome or ameliorate at least one of the disadvantages of the prior art, or to provide a useful alternative.

### SUMMARY OF THE INVENTION

An example embodiment provides a method for controlling a hydrocarbon gas pyrolysis system, wherein the hydrocarbon gas pyrolysis system includes a reactor subsystem having a reactor chamber in which a hydrocarbon gas is decomposed in presence of a conductive particulate material, the method comprising:
receiving time series input data from a reactor output sensor system provided by the hydrocarbon gas pyrolysis system, wherein the reactor output sensor system is configured to monitor composition of a reactor output that is released from the reactor subsystem;
processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
operating a control optimisation module to process data including the one or more parameters representative of real-time reactor subsystem output based on computer executable code, thereby to generate one or more control instructions; and
operating a control module thereby to deliver the one or more control instructions to effect control over at least one of: (i) a heating control system (optionally in which the heating control system controls a level of current and/or voltage applied to one or more electrodes which are configured to deliver current into the reactor chamber such that the current is propagated through the conductive particulate material); and (ii) a particulate matter delivery control system, wherein the particulate matter delivery control system is configured to control metered delivery of a primary particulate material into the reactor chamber.

In an example embodiment, the one or more parameters relate to each of: (i) a measure of hydrogen gas in the reactor output; and/or (ii) a measure of the one or more particulate materials in the reactor output. In another example embodiment, the one or more parameters relate to only one of: (i) a measure of hydrogen gas in the reactor output; and (ii) a measure of the one or more particulate materials in the reactor output.

In an example embodiment, the one or more control instructions effect control over each of the heating control system and the particulate matter delivery control system. In another example embodiment, the one or more control instructions effect control over only one of the heating control system and the particulate matter delivery control system.

In an example embodiment, the one or more parameters representative of real-time reactor subsystem output are derived from: a measure of relative prevalence of hydrogen gas in a gaseous mixture; a measure of purity of a hydrogen-based mixture; a quantity of hydrogen passing through a region as a function of time; a measure of fluidity in particles; a measure of the ratio of the primary particulate material relative to the conductive particulate material; and a temperature of a hydrogen-including output flow.

In an example embodiment, the one or more parameters representative of real-time reactor subsystem output are derived from: a metric related to quantum of one or more particulate materials being released from the reactor subsystem as a function of time; a metric related to particle size of one or more particulate materials released from the reactor subsystem; and a metric related to a morphology of one or more particulate materials released from the reactor subsystem.

In an example embodiment, the one or more control instructions include a control instruction is representative of one or more of: (i) an instruction to adjust a rate of release of the primary particulate material into the reactor chamber; (ii) an instruction to release a defined quantity of the primary particulate material into the reactor chamber at a defined rate; (iii) an instruction to perform a batched delivery of a defined quantity of the primary particulate material into the reactor chamber at a defined time; (iv) and instruction of adjust a rate of pneumatic transport fluid for the primary particulate material; batch size for the primary particulate material; or (vi) batch frequency for the primary particulate material.

In an example embodiment, the one or more control instructions include an instruction which results in increasing or decreasing an amount of current and/or voltage being delivered through the one or more electrodes of the heating control system (measured by current magnitude and/or total current per predefined time block, for example where pulsing currents are used).

In an example embodiment, the instruction which results in increasing or decreasing an amount of current and/or voltage being delivered through the one or more electrodes of the heating control system is representative of a defined target temperature variation within the reactor chamber.

In an example embodiment which results in increasing or decreasing an amount of current and/or voltage being delivered through the one or more electrodes of the heating control system is provided to a reactor control module for the reactor subsystem.

In an example embodiment the reactor subsystem includes a reactor controller module, and wherein operating the reactor control module thereby to deliver the one or more control instructions includes providing signals to the reactor controller module, thereby to cause the reactor control module to operate in a defined manner.

In an example embodiment causing the reactor control module to operate in a defined manner includes causing the reactor control module to: (i) increase or decrease heat in the reactor chamber; (ii) modify one or more fluidization parameters within the reactor chamber; or (iii) modify pressure in the reaction chamber.

In an example embodiment the reactor subsystem includes a fluidized bed reactor.

In an example embodiment the particulate matter delivery control system includes a quantity determination arrangement which is configured to measure a quantity of the primary particulate material prior to delivery to the fluidised bed reactor.

In an example embodiment the particulate matter delivery control system includes a particulate matter storage assembly coupled to a particulate matter delivery assembly, wherein the particulate matter delivery assembly includes at least one pre-pre-delivery chamber which is configured to be selectively pressurised during delivery of the primary particulate material prior to delivery to the reactor.

In an example embodiment the control optimisation module to process data is additionally configured to process data from one or more further sources, including: (i) a sensor configured to monitor temperature within the reactor chamber; (ii) an input representative of a predicted future temperature within the reactor subsystem; (iii) an input representative of one or more parameters derived from monitoring of particulate matter detected in the reactor subsystem output; (iv) an input representative of one or more input gas delivery parameters; (v) an input representative of desired future operating conditions for the reactor subsystem; and (vi) an input representative of one or more parameters relating to gasses other than hydrogen detected in the reactor subsystem output.

In an example embodiment the conductive particulate material includes one or more particulate materials is selected from the group comprising a graphitic starting material, a carbon material having encapsulated iron, iron ore, synthetic or naturally occurring iron oxide, or low quality iron oxide, preferably the electrically conductive material is selected from the group comprising a carbon material having encapsulated iron, iron ore, synthetic or naturally occurring iron oxide, or low quality iron oxide.

In an example embodiment the primary particulate material includes a catalytic particulate material for hydrocarbon pyrolysis within the reactor subsystem.

In an example embodiment the primary particulate material includes a material selected from the group comprising, a carbon material having encapsulated iron, iron ore, synthetic or naturally occurring iron oxide, or low quality iron oxide.

In an example embodiment the primary particulate material includes a graphitic material.

In an example embodiment the graphitic material selected from naturally occurring or synthetic graphite; flake graphite; and a form of electrically-conductive carbon.

In an example embodiment the control optimisation module is responsive to the one or more parameters representative of reactor subsystem outputs and additionally inputs representative of desired future operation for generating the one or more control instructions.

In an example embodiment the inputs representative of desired future operation include any one or more of: (i) desired hydrogen output parameters; (ii) desired output carbon parameters; and (iii) desired carbon output morphologies.

In a further example embodiment the invention includes a method for controlling a hydrocarbon gas pyrolysis system, wherein the hydrocarbon gas pyrolysis system includes a reactor subsystem having a reactor chamber in which a hydrocarbon gas is decomposed in presence of a conductive particulate material, the method comprising:
receiving time series input data from a reactor output sensor system provided by the hydrocarbon gas pyrolysis system, wherein the reactor output sensor system is configured to monitor composition of a reactor output that is released from the reactor subsystem;
processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
operating a control optimisation module to process data including the one or more parameters representative of real-time reactor subsystem output based on computer executable code, thereby to generate one or more control instructions; and
operating a control module thereby to deliver the one or more control instructions to effect control over at least one of: a heating control system, wherein the heating control system controls a temperature in the reactor chamber; and a particulate matter delivery control system, wherein the particulate matter delivery control system is configured to control metered delivery of a primary particulate material into the reactor chamber.

In a further example embodiment the invention includes a system for controlling a hydrocarbon gas pyrolysis system, wherein the hydrocarbon gas pyrolysis system includes a reactor subsystem having a reactor chamber in which a hydrocarbon gas is decomposed in presence of a conductive particulate material, the method comprising:
a data input module configured for receiving time series input data from a reactor output sensor system provided by the hydrocarbon gas pyrolysis system, wherein the reactor output sensor system is configured to monitor composition of a reactor output that is released from the reactor subsystem;
a processing module configured for processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
a control optimisation module operable to process data including the one or more parameters representative of real-time reactor subsystem output based on computer executable code, thereby to generate one or more control instructions; and
a control module operable thereby to deliver the one or more control instructions to effect control over at least one of: a heating control system, wherein the heating control system controls a temperature in the reactor chamber; and a particulate matter delivery control system, wherein the particulate matter delivery control system is configured to control metered delivery of a primary particulate material into the reactor chamber.

In a further example embodiment, the present invention comprises a method for hydrocarbon gas pyrolysis, the method comprising:
receiving input data from a sensor configured to monitor output of a fluidised bed reactor fed by an input of a hydrocarbon gas;
processing the input to determine one or more parameters representative of fluidised bed reactor output;
operating a control optimisation module which is responsive to the one or more parameters representative of fluidised bed reactor output for generating one or more control instructions;
applying at least one of the control instructions to a particulate matter delivery control system, wherein the particulate matter delivery control system is configured to control metered delivery of a particulate matter into the fluidised bed reactor.

In an embodiment, the one or more parameters include a parameter representative of a quantity of hydrogen gas or a ratio of hydrogen to hydrocarbon gas. This may include a rate of hydrogen gas throughput through a monitored region or a measure of the increasing proportion of hydrogen as represented by the ratio of hydrogen to hydrocarbon gas.

In an embodiment, the control instruction is representative of one or more of: (i) an instruction to adjust a rate of release of the particulate material into the fluidised bed reactor; (ii) an instruction to release a defined quantity of the primary particulate material into the reactor chamber at a defined rate; (iii) an instruction to perform a batched delivery of a defined quantity of the primary particulate material into the reactor chamber at a defined time; (iv) and instruction of adjust a rate of pneumatic transport fluid for the primary particulate material; batch size for the primary particulate material; or (vi) batch frequency for the primary particulate material.

In an embodiment, the particulate matter delivery control system includes a quantity determination arrangement which is configured to measure a quantity of the particulate material prior to delivery to the fluidised bed reactor. In an embodiment, the particulate matter delivery control system includes a particulate matter storage assembly coupled to a particulate matter delivery assembly, wherein the particulate matter delivery assembly includes a pre-pre-delivery chamber which is configured to be selectively pressurised during delivery of the particulate material prior to delivery to the fluidised bed reactor.

In an embodiment, the control optimisation module is additionally responsive to data derived from one or more further inputs for generating one or more control instructions. For example, the one or more further sensors may include any one or more of: (i) a sensor configured to monitor temperature within the fluidised bed reactor; (ii) an input representative of a predicted future temperature within the fluidised bed reactor; (iii) an input representative of one or more parameters derived from monitoring of particulate matter detected in the fluidised bed reactor output; (iv) an input representative of one or more input gas delivery parameters; (v) an input representative of desired future operating conditions for the fluidised bed reactor; and (vi) an input representative of one or more parameters relating to gasses other than hydrogen detected in the fluidised bed reactor output.

In an embodiment, the one or more sensors are spaced apart inside the fluidised bed reactor. In an embodiment, the one or more sensors are at distal ends of the fluidised bed reactor.

In an embodiment, the particulate material is selected from the group comprising a graphitic starting material, a carbon material having encapsulated iron, iron ore, synthetic or naturally occurring iron oxide, or low quality iron oxide, preferably the electrically conductive material is selected from the group comprising a carbon material having encapsulated iron, iron ore, synthetic or naturally occurring iron oxide, or low quality iron oxide.

In an embodiment, the particulate material is a catalytic particulate material for methane pyrolysis within the fluidised bed reactor. In an embodiment, the catalytic particulate material is selected from the group comprising, a carbon material having encapsulated iron, iron ore, synthetic or naturally occurring iron oxide, or low quality iron oxide.

In an embodiment, the particulate material is a non-catalytic particulate material selected to facilitate methane pyrolysis within the fluidised bed reactor. Preferably this is a graphitic material, for example selected from naturally occurring or synthetic graphite, preferably flake graphite. Other forms of carbon may be used, although it is preferable for forms of electrically-conductive carbon may be used (for example where the fluidised bed reactor is heated via flow of current (applied and/or inducted) through electrically conductive materials in the fluidised bed reactor. In some embodiments, if the carbon is non-conductive, a secondary material is present that is electrically-conductive, such as a silica or alumina based material.

The hydrocarbon gas may be any gas stream that comprises light hydrocarbons. Illustrative examples of hydrocarbon gas include, but are not limited to, natural gas, coal seam gas, landfill gas and biogas. The composition of the hydrocarbon gas may vary significantly but it will generally comprise one or more light hydrocarbons from a group comprising methane, ethane, ethylene, propane and butane. In a preferred embodiment, the hydrocarbon gas is selected from the group comprising methane, ethane, ethylene, propane and/or butane or mixtures thereof. In a preferred embodiment, the hydrocarbon gas consists essentially of one of methane, ethane, ethylene, propane or butane, preferably methane.

In an embodiment, the control instructions include control instructions for one or more other components which control aspects of hydrocarbon pyrolysis. Preferably the one or more other components include heat control components for the fluidised bed reactor.

In an embodiment, the control optimisation module which is responsive to the one or more parameters representative of fluidised bed reactor output and additionally inputs representative of desired future operation for generating the one or more control instructions. Preferably the inputs representative of desired future operation include any one or more of: (i) desired hydrogen output parameters; (ii) desired output carbon parameters; and (iii) desired carbon output morphologies.

In a second aspect the invention provides a system for controlling components used in a facility that performs hydrocarbon gas pyrolysis, the system comprising:
a module configured to receive input data from a sensor configured to monitor output of a fluidised bed reactor fed by an input of a hydrocarbon gas;
a processing module configured to process that input to determine one or more parameters representative of fluidised bed reactor output;
a control optimisation module which is responsive to the one or more parameters representative of fluidised bed reactor output for generating one or more control instructions; and
an output module that is configured to apply at least one of the control instructions to a particulate matter delivery control system, wherein the particulate matter delivery control system is configured to control metered delivery of a particulate matter into the fluidised bed reactor.

In an embodiment, the one or more parameters include a parameter representative of a quantity of hydrogen gas. This may include a rate of hydrogen gas throughput through a monitored region.

In an embodiment, the control instruction is representative of one or more of: (i) an instruction to adjust a rate of release of the particulate material into the fluidised bed reactor; (ii) an instruction to release a defined quantity of the primary particulate material into the reactor chamber at a defined rate; (iii) an instruction to perform a batched delivery of a defined quantity of the primary particulate material into the reactor chamber at a defined time; (iv) and instruction of adjust a rate of pneumatic transport fluid for the primary particulate material; batch size for the primary particulate material; or (vi) batch frequency for the primary particulate material.

In an embodiment, the particulate matter delivery control system includes a quantity determination arrangement which is configured to measure a quantity of the particulate material prior to delivery to the fluidised bed reactor. In an embodiment, the particulate matter delivery control system includes a particulate matter storage assembly coupled to a particulate matter delivery assembly, wherein the particulate matter delivery assembly includes a pre-pre-delivery chamber which is configured to be selectively pressurised during delivery of the particulate material prior to delivery to the fluidised bed reactor.

In an embodiment the control optimisation module is additionally responsive to data derived from one or more further inputs for generating one or more control instructions. For example, the one or more further sensors may include any one or more of: (i) a sensor configured to monitor temperature within the fluidised bed reactor; (ii) an input representative of a predicted future temperature within the fluidised bed reactor; (iii) an input representative of one or more parameters derived from monitoring of particulate matter detected in the fluidised bed reactor output; (iv) an input representative of one or more input gas delivery parameters; (v) an input representative of desired future operating conditions for the fluidised bed reactor; and (vi) an input representative of one or more parameters relating to gasses other than hydrogen detected in the fluidised bed reactor output.

In an embodiment, the particulate material is selected from the group comprising a graphitic starting material, a carbon material having encapsulated iron, iron ore, synthetic or naturally occurring iron oxide, or low quality iron oxide, preferably the electrically conductive material is selected from the group comprising a carbon material having encapsulated iron, iron ore, synthetic or naturally occurring iron oxide, or low quality iron oxide.

In an embodiment, the particulate material is a catalytic particulate material for methane pyrolysis within the fluidised bed reactor. In an embodiment, the catalytic particulate material is selected from the group comprising, a carbon material having encapsulated iron, iron ore, synthetic or naturally occurring iron oxide, or low quality iron oxide.

In an embodiment, the particulate material is a non-catalytic particulate material selected to facilitate methane pyrolysis within the fluidised bed reactor. Preferably this is a graphitic material, for example selected from naturally occurring or synthetic graphite, preferably flake graphite. Other forms of carbon may be used, although it is preferable for forms of electrically-conductive carbon may be used (for example where the fluidised bed reactor is heated via flow of current (applied and/or inducted) through electrically conductive materials in the fluidised bed reactor.

In an embodiment, the control instructions include control instructions for one or more other components which control aspects of hydrocarbon pyrolysis. Preferably the one or more other components include heat control components for the fluidised bed reactor.

In an embodiment, the control optimisation module which is responsive to the one or more parameters representative of fluidised bed reactor output and additionally inputs representative of desired future operation for generating the one or more control instructions. Preferably the inputs representative of desired future operation include any one or more of: (i) desired hydrogen output parameters; (ii) desired output carbon parameters; and (iii) desired carbon output morphologies.

In a further example embodiment, the present invention comprises a method for the pyrolysis of a hydrocarbon gas, the method comprising:
providing into a fluidised bed reactor an initial feedstock of an electrically conductive carbon material;
commencing operation of the fluidised bed reactor, wherein the fluidised bed reactor is fed by an input of the hydrocarbon gas;
operating a high frequency power supply thereby to deliver an alternating current to an electrically conductive coil which at least partially surrounds the fluidised bed reactor, thereby to cause an induction effect within the fluidised bed reactor, such that the induction effect causes electrical current to flow through the electrically conductive carbon material, thereby heating the electrically conductive carbon material to a predetermined temperature that initiates and maintains pyrolysis of the hydrocarbon gas; and
operating an outlet component thereby to release process materials from the fluidised bed reactor, wherein the released process materials include carbon materials, unreacted hydrocarbon gas and/or hydrogen gas.

In an embodiment, the hydrocarbon gas is, comprises or consists essentially of methane gas.

In an embodiment, the electrically conductive carbon material is selected from the group comprising a graphitic starting material, a carbon material having encapsulated iron, iron ore, synthetic or naturally occurring iron oxide, or low quality iron oxide.

In an embodiment, the method includes feeding into the fluidised bed reactor a supply of the electrically conductive carbon material.

In an embodiment, the electrically conductive carbon material is selected from the group comprising a carbon material having encapsulated iron, iron ore, synthetic or naturally occurring iron oxide, or low grade iron oxide.

In an embodiment, the predetermined temperature is between 600 and 1500 degrees centigrade, preferably between 800 and 1200 degrees centigrade.

In an embodiment, the graphitic starting material is selected from naturally occurring or synthetic graphite, preferably flake graphite.

In an embodiment, the method further includes a step of capturing at least a portion of the carbon materials extracted via the outlet and processing those carbon materials to produce regenerated graphitic material.

In an embodiment, the electrically conductive coil is centrally cooled.

In an embodiment, a plurality of electrically conductive coils are used.

In an embodiment, each of the electrically conductive coils is operable independently of one another to achieve the predetermined temperature.

In an embodiment, the predetermined temperature is between 600 and 1500 degrees centigrade, preferably between 800 and 1200 degrees centigrade.

In a further example embodiment, the present invention comprises a system for the pyrolysis of a hydrocarbon gas, the system comprising:
a fluidised bed reactor which is configured at start-up to contain an initial feedstock of a electrically conductive carbon material;
a gas input system for the fluidised bed reactor, which is configured to feed the fluidised bed reactor with an input supply of the hydrocarbon gas;
at least one electrically conductive coil at least partially surrounding the fluidised bed reactor;
a high frequency power supply configured to deliver an alternating current to the electrically conductive coil, thereby to cause an induction effect within the fluidised bed reactor, such that the induction effect causes electrical current to flow through the electrically conductive carbon material, thereby heating the electrically conductive carbon material to a predetermined temperature that initiates and maintains pyrolysis of the hydrocarbon gas; and
an outlet system configured to release process materials from the fluidised bed reactor, wherein the released process materials include carbon materials, unreacted hydrocarbon gas, and/or and hydrogen gas.

In an embodiment, the hydrocarbon gas is, comprises or consists essentially of methane gas.

In an embodiment, the electrically conductive carbon material is selected from the group comprising a graphitic starting material, a carbon material having encapsulated iron, iron ore, synthetic or naturally occurring iron oxide, or low quality iron oxide.

In an embodiment, the system includes feeding into the fluidised bed reactor a supply of the conductive carbon material.

In an embodiment, the electrically conductive carbon material is selected from the group comprising a carbon material having encapsulated iron, iron ore, synthetic or naturally occurring iron oxide, or low grade iron oxide.

In an embodiment, the predetermined temperature is between 600 and 1500 degrees centigrade, preferably between 800 and 1200 degrees centigrade.

In an embodiment, the graphitic starting material is selected from naturally occurring or synthetic graphite, preferably flake graphite.

In an embodiment, the system further includes a step of capturing at least a portion of the carbon materials extracted via the outlet and processing those carbon materials to produce regenerated graphitic material.

In an embodiment, the electrically conductive coil is centrally cooled.

In an embodiment, a plurality of electrically conductive coils are used.

In an embodiment, each of the electrically conductive coils is operable independently of one another to achieve the predetermined temperature.

In an embodiment, the predetermined temperature is between 600 and 1500 degrees centigrade, preferably between 800 and 1200 degrees centigrade.

In a further example embodiment, the present invention comprises a system for the pyrolysis of a hydrocarbon gas, the system comprising:
a fluidised bed reactor (FBR) which is at start-up configured to contain an initial feedstock of an electrically conductive carbon material;
a gas input system for the fluidised bed reactor, which is configured to feed the fluidised bed reactor with an input supply of the hydrocarbon gas;
at least one pair of electrically conductive electrodes configured to, in use, cause a flow of current through electrically conductive carbon material contained in the fluidised bed reactor, which at start-up includes the feedstock of the electrically conductive carbon material;
a high frequency power supply configured to deliver electrical current between the at least one pair of electrodes, thereby to cause the electrical current to flow through the electrically conductive carbon material contained in the fluidised bed reactor, thereby heating the electrically conductive carbon material to a predetermined temperature such that an average temperature that initiates and maintains pyrolysis of the hydrocarbon gas; and

an outlet system configured to release process materials from the fluidised bed reactor, wherein the released process materials include carbon materials, unreacted hydrocarbon materials, and/or and hydrogen gas.

In an embodiment, the hydrocarbon gas is, comprises or consists essentially of methane gas.

In an embodiment, the electrically conductive material includes an electrically conductive carbon material. In an embodiment, the electrically conductive material further comprises an inert/unreactive electrically conductive co-material (e.g., silica beads) that passes on heat to the surrounding process materials.

In an embodiment, there are multiple pairs of electrodes. In such an embodiment, optionally a single electrode is a member of two or more pairs of the multiple pairs of electrodes.

In a further example embodiment, the present invention comprises a system for the pyrolysis of a hydrocarbon gas, the system comprising:
a fluidised bed reactor (FBR);
a gas input system for the fluidised bed reactor, which is configured to feed the fluidised bed reactor with an input supply of the hydrocarbon gas;
at least one heating element disposed within the fluidised bed reactor;
a high frequency power supply configured to deliver high frequency power to the at least one heating element, thereby to cause heating within the fluidised bed reactor to a predetermined temperature that initiates and maintains pyrolysis of the hydrocarbon gas; and
an outlet system configured to release process materials from the fluidised bed reactor, wherein the released process materials include carbon materials, unreacted hydrocarbon materials, and/or and hydrogen gas.

In an embodiment, the hydrocarbon gas is, comprises or consists essentially of methane gas.

In an embodiment, the system comprises a plurality of heating elements. In an embodiment, each of the plurality of heating elements can be individually controlled to maintain the average temperature. In some embodiments, there are multiple heating elements respectively configured to apply heat in distinct zones within the fluidised bed reactor. Preferably, in some embodiments, such heating elements are individually controllable thereby to apply variable heat at the distinct zones within the fluidised bed reactor. In some embodiments, the distinct zones may be defined based on vertical/horizontal and/or radial coordinates.

In further example embodiment, the present invention comprises a system for the pyrolysis of a hydrocarbon gas, the system comprising:
a fluidised bed reactor (FBR);
a gas input system for the fluidised bed reactor, which is configured to feed the fluidised bed reactor with an input supply of the hydrocarbon gas;
at least one heating element disposed at a sidewall of the fluidised bed reactor;
a high frequency power supply configured to deliver high frequency power to the at least one heating element, thereby to cause heating within the fluidised bed reactor to a predetermined temperature that initiates and maintains pyrolysis of the hydrocarbon gas; and
an outlet system configured to release process materials from the fluidised bed reactor, wherein the released process materials include carbon materials, unreacted hydrocarbon materials, and/or and hydrogen gas.

In an embodiment, the hydrocarbon gas is, comprises or consists essentially of methane gas.

In an embodiment, the system comprises a plurality of heating elements. In embodiment, each of the plurality of heating elements are respectively configured to apply heat in distinct zones within the fluidised bed reactor. Preferably, such heating elements are individually controllable thereby to apply variable heat at the distinct zones within the fluidised bed reactor to maintain the average temperature. In some embodiments, the distinct zones may be defined based on vertical/horizontal and/or radial coordinates.

In a further example embodiment, the present invention comprises system for the pyrolysis of a hydrocarbon gas, the system including:
a fluidised bed reactor (FBR);
a gas input system for the fluidised bed reactor, which is configured to feed the fluidised bed reactor with an input supply of the hydrocarbon gas;
a plurality of heating arrangements (inside or outside the reactor, i.e., hot or cold walled reactor) configured to apply heat to the fluidised bed reactor;
a high frequency power supply system configured to deliver high frequency power to the or each of the heating arrangements, thereby to cause heating within the fluidised bed reactor to a predetermined temperature that initiates and maintains pyrolysis of the hydrocarbon gas; and
an outlet system configured to release process materials from the fluidised bed reactor, wherein the released process materials include carbon materials, unreacted hydrocarbon materials, and/or and hydrogen gas.

In an embodiment, the hydrocarbon gas is, comprises or consists essentially of methane gas.

Preferably, the or each of the plurality of heating arrangements include at least two distinct heating arrangement types selected from the group including: at least one heating element disposed at a sidewall of the fluidised bed reactor; at least one heating element disposed within the fluidised bed reactor; at least one pair of electrically conductive electrodes configured to, in use, cause a flow of current through electrically conductive material contained in the fluidised bed reactor thereby to cause heating of electrically conductive materials; and at least one electrically conductive coil wound around the fluidised bed reactor configured to, in use, cause a flow of current through electrically conductive material contained in the fluidised bed reactor thereby to cause heating of electrically conductive materials.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Throughout this specification, unless the context requires otherwise, the term “low grade” will be understood to imply that the material that is not synthesised. As would be understood by a person skilled in the art, synthesised materials are produced by the chemical reaction of precursor materials. Standard synthesis techniques for catalysts which are excluded from the present invention are, for example, impregnating nano-sized catalytic elements onto inert supports. Whilst the term “low grade” does include naturally occurring materials, it should not be understood to exclude materials that have gone through physical beneficiation such as crushing and screening or classification.

As used herein, the term “dusting” is an industry term used to describe a reaction that disintegrates metallic material (often ferrous) into fragments and graphite within a carburizing environment. This effect begins by methane molecules (or other carbonaceous gases) adsorbing and dissociating on the surface of the metal-containing catalyst and the resulting carbon diffusing into the surface of the bulk metal. Once this outer layer is saturated with carbon, it forms metal carbide and then precipitates from the metallic grain boundaries as graphitic carbon. Over time this causes inter-granular pressure that separates the metal carbide particles from the parent bulk metal, and causes the metal structure to disintegrate by ‘dusting’. In doing so, the catalyst separates and fragments into nano-fragments and become encapsulated in carbon/graphite. The resulting graphitic carbon materials encapsulating Fe particles are hereinafter referred to as “a carbon material having encapsulated iron” or “Hazer graphite”.

The term “hydrocarbon gas” is intended to encompass pure single gases, e.g., methane, or gad mixtures comprising one or more hydrocarbon gases, e.g., natural gas. Whereas a preferred embodiment of the invention relates to methane pyrolysis (or pyrolysis of a methane-containing gas stream), it will be understood that other hydrocarbon gases, e.g., ethane, propane, etc., are also amenable to the technology described herein.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

As used herein, the term “power supply” can refer to alternating or direct current supplies.

With respect to the terms “comprising”, “consisting of”, and “consisting essentially of”, where one of these three terms is used herein, the presently disclosed and claimed subject matter may include the use of either of the other two terms. Thus, in some embodiments not otherwise explicitly recited, any instance of “comprising” may be replaced by “consisting of” or, alternatively, by “consisting essentially of”.

Other than in the operating examples, or where otherwise indicated, all numbers expressing quantities of ingredients or reaction conditions used herein are to be understood as modified in all instances by the term “about”, having regard to normal tolerances in the art. The examples are not intended to limit the scope of the invention. In what follows, or where otherwise indicated, “%” will mean “weight %”, “ratio” will mean “weight ratio” and “parts” will mean “weight parts”.

The term “substantially” as used herein shall mean comprising more than 50% by weight, where relevant, unless otherwise indicated.

The term “about” should be construed by the skilled addressee having regard to normal tolerances in the relevant art.

The recitation of a numerical range using endpoints includes all numbers subsumed within that range (e.g., 1 to 5 includes 1, 1.5, 2, 2.75, 3, 3.80, 4, 5, etc.).

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

It must also be noted that, as used in the specification and the appended claims, the singular forms “a”, “an” and “the” include plural referents unless the context clearly dictates otherwise.

The prior art referred to herein is fully incorporated herein by reference unless specifically disclaimed.

Although example embodiments of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

This specification is prepared having regard to the principles of general application. As such, where the specification discloses a principle of general application, the claims may be drafted in correspondingly general terms (Biogen v Medeva [1997] RPC 1 at 48). A “principle of general application” is a general principle that can be practically applied in making a class of products, or in working a process, including where the claims define the products or process(es) in terms of the result to be achieved.

A feature in the claims stated in general terms will represent a principle of general application, where it is reasonable to expect (reasonable to predict) that the claimed invention will work with anything that falls within the general term. Such a feature defined in general terms may be a major part of the claim, or it may be a simple descriptive word. In either case, a feature in the claims expressed in general terms will be sufficiently enabled if the disclosure enables at least one form of, or one application of, a general principle in respect of the feature, and the person skilled in the art would reasonably expect the invention to work with anything that falls within the general term. (Kirin-Amgen Inc. v Hoechst Marion Roussel Ltd [2005] RPC 9 at [112]).

Where the claims are more broadly drafted they may be considered enabled if, prima facie: a) the disclosure teaches a principle that the person skilled in the art would need to follow in order to achieve each and every embodiment falling within a claim; and b) the specification discloses at least one application of the principle and provides sufficient information for the person skilled in the art to perform alternative applications of the principle in a way that, while not explicitly disclosed, would nevertheless be obvious to the person skilled in the art (T 484/92).

Example embodiments are described below in the section entitled “claims”.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

The present invention is not to be limited in scope by any of the specific embodiments described herein. These embodiments are intended for the purpose of exemplification only. Functionally equivalent products, formulations and methods are clearly within the scope of the invention as described herein.

The invention described herein may include one or more range of values (e.g., size, concentration etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description of the invention and apply throughout. Unless otherwise defined, all other scientific and technical terms used herein have the same meaning as commonly understood to one of ordinary skill in the art to which the invention belongs.

Throughout this specification, unless the context requires otherwise, the term “selectively synthesise” will be understood refer to the preferential synthesis of one morphology over the others. Whilst the process of the present invention will often produce a mixture of morphologies, the Applicant has determined that the selection of the temperature and pressure of the process has an effect on the morphology of the graphite so produced.

Throughout this specification, unless the context requires otherwise, it will be appreciated that the process of the present invention can be conducted at more than one temperature and/or pressure within a specified range. For example, if a temperature range of 600° C. to 800° C. is provided, the step of contacting the metal-containing catalyst with a hydrocarbon gas could initially be performed at 600° C., with the temperature being increased to 800° C. during the contact of the metal-containing catalyst with a hydrocarbon gas. Similarly, if a pressure range of 0 bar(g) to 8 bar(g) is provided, the step of contacting the metal-containing catalyst with a hydrocarbon gas could initially be performed at 0 bar(g), with the pressure being increased to 8 bar(g) during the contact of the metal-containing catalyst with a hydrocarbon gas.

Throughout this specification, unless the context requires otherwise, the term “selectivity” refers to the percentage of the produced graphitic material with the desired morphology.

Throughout this specification, unless the context requires otherwise, the term “bar(g)” refers to gauge pressure. As would be understood by the skilled addressee, gauge pressure refers to pressure in bars above ambient pressure.

As used in this specification, the term “predetermined value ranges” refers to a particular range of pressures and temperatures that may be selected by the skilled person to selectively synthesise graphitic material with a desired morphology. The person skilled in the art would be able to select an appropriate temperature or temperatures and pressure or pressure within these ranges to selectively synthesise the desired graphitic material.

Features of the invention will now be discussed with reference to the following non-limiting description and examples.

### BRIEF DESCRIPTION OF THE DRAWINGS

Embodiments of the invention will now be described, byway of example only, with reference to the accompanying drawing in which:

FIG. 1 illustrates provides a schematic overview of an example hydrocarbon pyrolysis system, as context to embodiment of control technology described herein.

FIG. 2 illustrates a system configured to enable improved/optimised control of a hydrocarbon pyrolysis process, shown in conjunction with select components of a broader hydrocarbon pyrolysis system.

FIG. 3A illustrates a first heating arrangement for a hydrocarbon pyrolysis system according to one embodiment.

FIG. 3B illustrates a second heating arrangement for a hydrocarbon pyrolysis system according to one embodiment.

FIG. 4 provides a table which sets out representative relationships between controlled and manipulated variables according to one embodiment.

### DETAILED DESCRIPTION OF A PREFERRED EMBODIMENT

The present invention relates, in various embodiments, to system and methods configured to enable improved/optimised control of a hydrocarbon pyrolysis process. Embodiments have been developed for implementation in a context of hydrocarbon gas pyrolysis systems in which there is a reactor subsystem having a reactor chamber in which a hydrocarbon gas is decomposed in presence of a conductive particulate material.

### Overview of Control Optimisation Technology

In overview, various embodiments disclosed wherein relate to technology which enables control over a particular form of hydrocarbon gas pyrolysis system, enabling control for the purposes of process improvement and/or optimisation based on particular objectives, and/or for other purposes (for example to achieve desired output and/or operational parameters). The disclosure relates to the configuration of various hardware components and the pyrolysis system as a whole, as opposed to specific detailed logic associated with operational control or optimisation techniques. However, it will be appreciated that the technology disclosed herein is able to be configured/operated in a manner which achieves optimisation or other intentional control, for example via facility-specific testing and knowledge building, and/or implementation of known technologies such as machine learning.

The technology disclosed herein relates to hydrocarbon gas pyrolysis systems which include a reactor subsystem, the reactor subsystem having a reactor chamber in which a hydrocarbon gas is decomposed in presence of a conductive particulate material. This conductive particulate material serves a double purpose; it both assists in the decomposition process, and additionally facilitates heating of a fluidised mixture of particulates and gas within the reactor chamber.

The hydrocarbon gas may be any gas stream that comprises light hydrocarbons. Illustrative examples of hydrocarbon gas include, but are not limited to, natural gas, coal seam gas, landfill gas and biogas. The composition of the hydrocarbon gas may vary significantly but it will generally comprise one or more light hydrocarbons from a group comprising methane, ethane, ethylene, propane and butane. In a preferred embodiment, the hydrocarbon gas is selected from the group comprising methane, ethane, ethylene, propane and/or butane or mixtures thereof. In a preferred embodiment, the hydrocarbon gas consists essentially of one of methane, ethane, ethylene, propane or butane, preferably methane.

Embodiments focus in particular on a heating arrangement whereby electrodes are disposed within the reactor chamber, and a current is applied to one at least one of those electrodes thereby to cause a current to flow through the conductive particulate material, with resistive effects resulting in heating. For example, the reactor subsystem may take the form of a fluidised bed reactor (FBR). Control over the magnitude of current applied vis the electrode(s), optionally in addition to other FBR controls such as fluidization controls, have implications in terms of the increase/decrease of temperature within the reactor chamber.

It will be appreciated that FBR technologies are known, and the concept of heating of FBRs via electrodes in this manner is also known. However, the application of such known concepts and technologies to the present specific environment results in added complications, which cannot be solved through FBR controls exclusively. In particular, for the systems discussed herein, the quantum of particulate material within the reactor chamber is not fixed. Rather, there is both insertion and extraction of particulate material, and changes in the composition/morphology of the particulate material. For example:
Within the reactor chamber, there is at all times a conductive particulate material, which in this case includes graphitic carbon or iron substantially encapsulated by graphitic carbon. This is required to effect electrode-induced heating within the reactor chamber.
A particulate matter delivery control system is configured to control metered delivery of a primary particulate material into the reactor chamber.
The primary particulate material, which may include iron oxide (synthetic or naturally occurring), may be introduced as a low-conductivity particulate material, and subsequent transition into a higher conductivity particulate material (for example carbon encapsulated iron) as carbon produced trough the hydrocarbon decomposition process is deposited on the iron oxide.
The deposition of carbon is not limited only to the iron oxide, but also occurs on carbon particles, including the carbon encapsulated iron.

The conductive particulate material preferably is selected from the group comprising a carbon material having encapsulated iron, iron ore, synthetic or naturally occurring iron oxide, or low quality iron oxide. The primary particulate material preferably includes a carbon material having encapsulated iron, iron ore, synthetic or naturally occurring iron oxide, or low quality iron oxide. Where the primary particulate material is a catalytic particulate material for methane pyrolysis within the fluidised bed reactor, the catalytic particulate material is selected from the group comprising, a carbon material having encapsulated iron, iron ore, synthetic or naturally occurring iron oxide, or low quality iron oxide. In some cases the primary particulate material is a non-catalytic particulate material selected to facilitate methane pyrolysis within the fluidised bed reactor. Preferably this is a graphitic material, for example selected from naturally occurring or synthetic graphite, preferably flake graphite. Other forms of carbon may be used, although it is preferable for forms of electrically-conductive carbon may be used (for example where the fluidised bed reactor is heated via flow of current (applied and/or inducted) through electrically conductive materials in the fluidised bed reactor.

The quantum of particulate materials within the reactor chamber, along with the overall composition and morphologies of those particulate materials, has a direct effect on multiple parameters relevant to the pyrolysis process. For example, this will affect: (i) the rate and efficiency with which pyrolysis occurs at a given temperature (and/or fluidization rate); (ii) relationship between current and heating effect (e.g. for a given fluidization rate); (iii) operational settings of a fluid bed reactor to achieve a desired fluidization rate; and (iv) morphological properties of reacting and extracted particulate materials.

Accordingly, the present disclosure sets out hardware configurations and processes which are applied thereby to enable improved/optimised control of a hydrocarbon pyrolysis process in such as scenario. This enables a range of advantages, discussed below, including (but not limited to) mitigation of issues relating to unwanted carbon surface deposition, an ability to adjust catalytic inputs, control over residence time, and control over products' (such as carbon, particularly graphitic carbon in various morphologies, and hydrogen) purity. Other advantages may include larger scaling capability, better temperature control, simpler construction, enhanced energy efficiency.

### Example Pyrolysis Control Process

In an example embodiment, a computer-implemented method is performed which includes receiving time series input data from a reactor output sensor system provided by the hydrocarbon gas pyrolysis system. The reactor output sensor system is configured to monitor composition of a reactor output that is released from the reactor subsystem. For example, this may include composition of gaseous and/or particulate substances outputted from the reactor subsystem (and preferably both). The time series data preferably includes separate streams (with respective sampling rates and latency/delay attributes) for individual sensors.

The method then includes processing the time series input data thereby to determine one or more parameters representative of real-time reactor subsystem output. The one or more parameters representative of real-time reactor subsystem output relate to either or both of: (i) a measure of hydrogen gas in the reactor output; and (ii) a measure of particulate material in the reactor output. That is, in some embodiments parameters relating to both are calculated, whereas in other embodiments the calculated parameters relate to only one of those measures.

Outlet components which enable release of gases and particulate materials from the reactor subsystem/reactor chamber may be operated controllably or without control. In one embodiment, it is uncontrolled (the flow of solids from the reactor being an outcome of particle elutriation). The rate of elutriation will therefore be a function of geometry, flow rate, and overall design. Other means of operating the outlet component are contemplated.

By way of example, in circumstances where the parameters representative of real-time reactor subsystem output relate to a measure of hydrogen gas in the reactor output, those parameters may be derived from any one or more of:
a measure of relative prevalence of hydrogen gas in a gaseous mixture;
a measure of purity of a hydrogen-based mixture;
a quantity of hydrogen passing through a region as a function of time;
a gas flow rate; and
a temperature of a hydrogen-including output flow.

Likewise, in circumstances where the parameters representative of real-time reactor subsystem output relate to a measure of conductive particulate material, that measure may be derived from any one or more of:
a metric related to quantum of one or more particulate materials being released from the reactor subsystem as a function of time;
a metric related to particle size of one or more particulate materials released from the reactor subsystem; and
a metric related to morphology of one or more particulate materials released from the reactor subsystem.

For clarity, the term “real time” as used in this specification indicates that the parameters are able to be reasonably functionally correlated to current conditions within the reactor chamber. This may include a process of forward extrapolation, or otherwise accept/account for delays resulting from, for example the time between materials leaving the reactor and being observed by sensors. A delay in the order of seconds or minutes is considered as being “real-time” in the present context.

As further context, in embodiments where the primary particulate material is catalyst (e.g. iron oxide, which reacts to become iron, and is then encapsulated in graphite from the decomposing hydrogen), there is a particular interest in data representative of a catalyst/gas ratio in the reaction chamber as compared to hydrocarbon (e.g. methane) conversion. An additional factor of interest is hydrogen purity in the output (and/or hydrogen production) relative to the rate at which hydrocarbon feed gas is provided to the reactor chamber. Other relevant factors include reactor temperature, bed level, gas residence time (in dense bed) and operating pressure. It will be appreciated that gas feed rate, reactor heat input, reactor pressure, and particulate release rate/metering rate are primary manipulated or independent variables. Dependant variables are hydrogen purity, hydrogen production, graphite purity (noting the manner by which the iron oxide reacts in the chamber to form iron encapsulated in graphite), ratio of primary particulate material vs conductive particulate material (optionally calculated via monitoring a conductivity related measure in the output flow), or more specifically iron/iron oxide graphite encapsulating iron), and hydrocarbon/methane conversion rate. Any one or more of the dependent variables (or measures directly/indirectly representative thereof) are optionally quantified, thereby to enable the system to control one or more of the primary manipulated or independent variables, such as particulate insertion release rate/metering, feed rate, and/or various parameters such as reactor chamber temperature, pressure and fluidization parameters which may be controlled by a processor associated with the FBR.

The method then includes executing computer executable code via a control optimisation module, thereby to process data which includes the one or more parameters representative of real-time reactor subsystem output (and optionally other real-time data in combination). This causes the generation of one or more control instructions. A control module is operated thereby to deliver the one or more control instructions to effect control over components within the pyrolysis system. This may include controlling either or both of:
(i) A heating control system. For example, this is in some embodiments a heating control system which controls a level of current and/or voltage that is applied to one or more electrodes, these electrodes being in turn configured to deliver current into the reactor chamber such that the current is propagated through the conductive particulate material (hence effecting heating within the reactor chamber). In some embodiments control over the heating system is indirect, and performed via communication with a separate reactor control module that controls operation of the reactor subsystem (which is in some embodiments a FBR). For example, the FBR may operate its heating controls (e.g. current delivered to electrodes) based on a defined temperature target, and the control instruction delivered by the control optimisation module is representative of an instruction to adjust that target temperature.
(ii) A particulate matter delivery control system. The particulate matter delivery control system is configured to control metered delivery of the primary particulate material into the reactor chamber. For example, the particulate matter delivery control system includes a quantity determination arrangement which is configured to measure a quantity of the primary particulate material prior to direct/indirect delivery into the reactor chamber. In some embodiments the particulate matter delivery control system includes a particulate matter storage assembly coupled to a particulate matter delivery assembly, wherein the particulate matter delivery assembly includes a pre-pre-delivery chamber which is configured to be selectively pressurised during delivery of the primary particulate material prior to delivery to the reactor chamber.

Preferably, the control optimisation module and control module are configured to enable delivery of control signals to both of these systems. However, it will be appreciated that the latter is particularly crucial. It should be noted that the control optimisation module need not be used for strictly “optimisation” purposes, and that control may be implemented for a range of purposes, for example improvement, testing, start-up/shut-down, ramp-up/ramp-down, intentional de-optimisation, and others. The label “optimisation” in “control optimisation module” is representative only.

There are various references to controlling current and/or voltage. It should be recognised that there may be advantages to control one of these, and let the other float. For example, this may influence rate of heating with reactor chamber (i.e. fluidized bed); superficial velocity of particulate material impact resistances and therefore rate of heating.

The concept of heating control as discussed herein is not limited only to the control (direct or indirect) of a FBR heating system (e.g. current/voltage delivered via electrodes). Heating control may also be achieved via other factors, for example reactor pressure (which will have an effect on resistivity), rate of primary particulate deliver and particulate extraction (e.g. graphite purity relative in the chamber will have a direct effect on resistivity).

The one or more control instructions include an instruction to the reactor control system (i.e. a processor which controls operating parameters of a fluidized bed reactor) thereby to cause adjustment in relation to any one or more of heating, fluidization rate and/or pressure.

The control optimisation module is in some embodiments additionally configured to process data is additionally configured to process data from one or more further sources. These may include any one or more of (i) a sensor configured to monitor temperature within the reactor chamber; (ii) an input representative of a predicted future temperature within the reactor subsystem; (iii) an input representative of one or more parameters derived from monitoring of particulate matter detected in the reactor subsystem output; (iv) an input representative of one or more input gas delivery parameters; (v) an input representative of desired future operating conditions for the reactor subsystem; and (vi) an input representative of one or more parameters relating to gasses other than hydrogen detected in the reactor subsystem output.

In some embodiments, where multiple real-time parameters are observed, a subset of one or more of those parameters are defined as target parameters, and assigned target values/ranges. Control instructions are then defined based on an optimisation method which seeks to manipulate and maintain the target parameters within the assigned target values/ranges. For example, the target parameters may include (i) desired hydrogen output parameters; (ii) desired output carbon parameters; and (iii) desired carbon output morphologies.

### Example Pyrolysis Framework

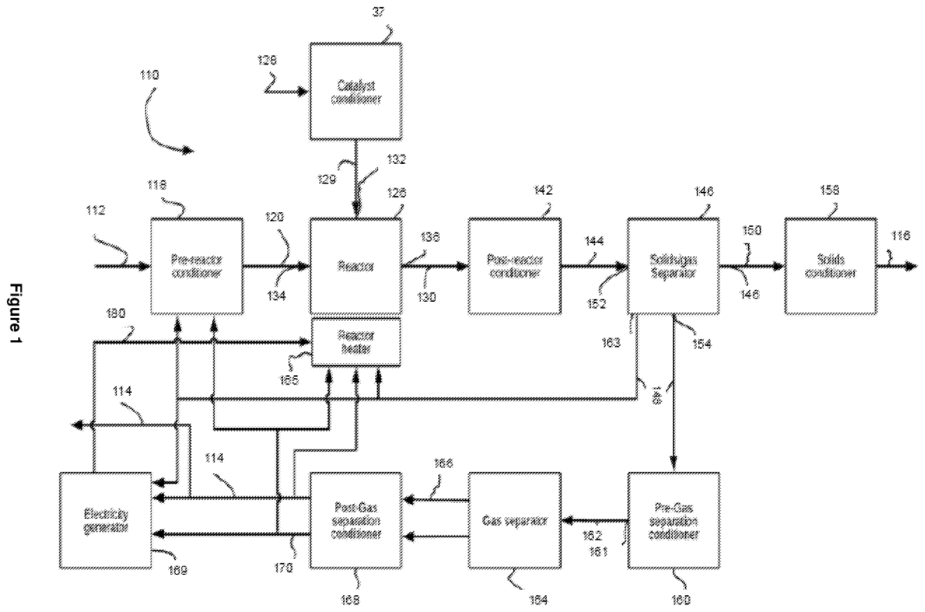

FIG. 1 illustrates a system 110 for the conversion of a hydrocarbon feedstock 112 to hydrogen gas 114 and graphitic carbon 116. This is described thereby to provide a general example of a system to which control optimisation technologies described herein are optionally applied. However, it should be appreciated that system 110 should not be treated as an unnecessarily limiting example. Additional disclosure in relation to how control optimisation technologies are implemented are provided further below, these referring back to the example of system 110.

The hydrocarbon feedstock 112 is introduced into an optionally present pre-reactor conditioner 118 adapted to condition the hydrocarbon feedstock 112 to produce a conditioned hydrocarbon feedstock 120. In a preferred embodiment, the hydrocarbon feedstock is selected from the group comprising methane, ethane, ethylene, propane and/or butane or mixtures thereof. In a preferred embodiment, the hydrocarbon feedstock consists essentially of one of methane, ethane, ethylene, propane or butane, preferably methane.

The pre-reactor conditioner 18 is adapted to perform one or more of heating, pressurising, plasma treatment, cooling, desulfurisation, drying, purification and expansion of the hydrocarbon feedstock 12 producing a conditioned hydrocarbon feedstock 20.

The pre-reactor conditioner is in communication with one or more reactors 26. The one or more reactors 26 are adapted to contact at a temperature between 600° C. and 1000° C. (or higher) a conditioned iron oxide catalyst 29 with the conditioned hydrocarbon feedstock 20 to produce a mixed phase stream 30 containing hydrogen gas, graphitic carbon, and unreacted hydrocarbon. Each reactor 26 comprises a catalyst inlet 32, a gas inlet 34 and a mixed phase outlet 36. The pre-reactor conditioner will typically increase the temperature and pressure of the hydrocarbon feedstock prior to injection into the one or more reactors 26.

In communication with the catalyst inlet 132 is a catalyst conditioner 137. The catalyst conditioner 137 is adapted to condition the iron oxide catalyst 128 prior to entry to the one or more reactors 126 to produce a conditioned iron oxide catalyst 129. It is envisaged the conditioning may include one or more of beneficiation, washing, drying, crushing, milling, sieving, purification, and heating of the catalyst.

The mixed phase outlet 136 is in communication with a post-reactor conditioner 142. The post-reactor conditioner 142 is adapted to condition the mixed phase stream 130 to produce a conditioned mixed phase stream 144. The post-reactor conditioner 142 may do any one or more of dewatering, cooling, and/or extraction of volatiles of the mixed phase stream 130, preferably post-reactor conditioner 142 cools and/or dewaters mixed phase stream 130.

The post-reactor conditioner 142 is in communication with one or more solid/gas separators 146. One or more solid/gas separator 146 comprise an inlet 152, a gas outlet 54, a second gas outlet 163, and a solid outlet 156. The one or more solid/gas separators 46 are adapted to separate at least a portion of the conditioned mixed phase stream 144 into a gas stream 148 comprising hydrogen gas and a solid stream 150 comprising graphitic carbon. It is envisaged that the second gas outlet 163 may optionally be in communication with one or more of the pre-reactor conditioner 118, reactor heater 165, and/or electricity generator 169 such that at least a portion of gas stream 148 may be recycled. Electricity generator 169 may optionally be used to provide electricity 180 to reactor heater 165 or to other parts of the system, as required.

The solid outlet 156 is in communication with a solids conditioner 158. The solids conditioner 158 is adapted to condition the solid stream 150 to produce a graphitic carbon stream 16. The solids conditioner 158 may perform one or more of the conditioning functions of packaging (pelletising, compressing), functionalising, and/or purifying the solid stream 150.

The gas outlet 154 is in communication with a pre-gas separation conditioner 160, which comprises a conditioned gas outlet 161, such that at least a portion of the gas stream 148 is conditioned to produce a conditioned gas stream 162. The pre-gas separation conditioner 160 may do any one or more of pressurising, cooling, scrubbing/purification to remove impurities of the gas outlet product 148, preferably pre-gas separation conditioner 160 pressurises and/or scrubs gas stream 148.

The pre-gas separation conditioner 160 is in fluid connection with a gas separator 164 which is adapted to separate and purify at least a portion of the components of the gas stream 162 to produce one or more purified gaseous product streams 166. At least one of the purified gaseous product streams 166 comprises hydrogen gas.

The gas separator 164 is in communication with a post-gas separation conditioner 168 adapted to condition the purified gaseous product streams 166 to provide hydrogen gas 114 in purified form and one or more conditioned gaseous streams 170 that may comprise one or more of CH₄, CO₂, CO or the mixed gaseous stream. Purified hydrogen stream 114 may be connected to one or more gas storage tanks, piped to an end user, or optionally used as an energy means for one or each of the one or more of or all of the conditioners 118, 142, 158, 160, 168 or reactor heater 165, or optionally fed into electricity generator 169 for electricity generation. Reactor heater 165 may directly or indirectly heat reactor 126, and more extensive discussion of reactor heater technologies are described further below.

When conditioned gaseous product stream 170 comprises a mixed gaseous stream of one or more of CO, CH₄ and CO₂, the mixed gaseous stream may also be optionally connected to pre-reactor conditioner 18 for supply to the one or more reactors as the hydrocarbon feedstock or optionally fed into electricity generator 169 for electricity generation. Electricity generator 169 may optionally be used to provide electricity 180 to reactor heater 165 or to other parts of the system, as required.

Sensors configured to collect data for the purposes of enabling control optimisation may be located at a range of locations throughout system 110. It will be appreciated that this will be a matter of design choice, based on (for example) the nature of sensor, the parameters that are to be observed/determined, and tolerable latency/delay from being representative of current reactor conditions.

In relation to heating, the system of FIG. 1 illustrates a reactor 126 and an associated reactor heater 165. In the case that the reactor is a fluidised bed reactor (FBR). In such a configuration, the contents of the reactor (for example including catalyst, carbon, methane and hydrogen, collectively referred to as “process materials”) is maintained in an agitated fluidised state whereby the process materials are substantially homogenous throughout the reactor (i.e. preferably without substantive vertical or horizontal stratification). The manner by which the reactor heater is configured and controlled has a bearing on the manner by which reactions occur in the reactor. The following heating technologies are optionally used in various embodiments (either in isolation or in combination).

### Electrified Bed Heating

In such configurations, one or more electrodes, for example including one or more pairs of electrodes, are positioned within the FBR, thereby to cause current flow from a first of the electrodes of a pair to the second electrode of that pair (optionally with a given electrode forming part of multiple pairs). In such a configuration, there is a resultant flow of current through the electrically conductive carbon within the process materials, which increases in temperature dues to resistive qualities. As a result, the electrically conductive carbon in essence behaves as a resistive heating element (while in a homogenised fluidised state within the FBR), causing overall heating of the process materials. It should be noted that in some embodiments there is an odd number of electrodes (for example three, optionally using alternating current), resulting in one or more pairs of electrodes, plus an additional electrode.

In some embodiments, the positioning of electrodes is configured to enable differential heating of distinct zones/pathways within the FBR. This is optionally combined with internal sensors (for example zone-specific temperature sensors) and a control system which is configured to apply differential current flows within the zones (and/or along different pathways) thereby to encourage modified fluid movement behaviours within the process materials. This may be used to achieve functions including optimisation of temperature consistency and/or resolving of identified trends towards stratification of the process materials (e.g., by encouraging convection style movement).

### External Resistive Heating (Hot Wall)

In this example, heat is applied directly through sidewall of the FBR, for example via external resistive elements. Heating of the process materials in this instance relies upon proximity of or contact of the process materials to the FBR sidewall. This approach has advantages in terms of overall simplicity, however there are potential scale limitations as the internal FBR radius increases (for example given a need to apply increased heat through the sidewalls thereby to achieve a desired consistent temperature throughout the process materials). Higher energy transfer through walls is required at larger radius and will be ultimately limited by material strength at elevated temperatures.

### Internal Resistive Heating (Cold Wall)

In this example, heat is applied via elements which are disposed within the central cavity of the FBR. The shape, position and configuration of these elements may be tuned based on reactor size, for example. to encourage efficient consistent heating. As a general principle for all heating examples described herein, there are advantages associated with optimising/limiting a difference in temperature between (i) the external surface of the heating elements; and (ii) a target temperature for the process materials (selected based on optimal reaction conditions and/or reaction conditions tuned for desired output results). The shape, position and configuration of these elements may also be tuned based on other factors, for example to encourage agitation and/or homogeneity of the process materials. For example, one preferred embodiment makes use of a plurality of heating elements which are shaped and/or positioned thereby to encourage movement of the process materials within the FBR thereby to optimise efficient and consistent heating throughout the process materials.

Another preferred embodiment makes use of a single heating element having a complex three dimensional shape (for example, a helix or coil) which encourages movement of the process materials within the FBR thereby to optimise efficient and consistent heating throughout the process materials. In an embodiment, such a heating element may be included as one or more heating elements in the FBR to optimise the heating of the process materials. In an embodiment, the one or more heating elements are arranged in a double helix arrangement or coils of differing diameter. In an embodiment, the coils are in the form of tight spirals (like springs).

In an embodiment, the one or more heating elements reside inside a larger heating element. In some embodiments, the one or more heating elements are operable individually. In some embodiments there are a plurality of individually controllable heating elements, each occupying a respective zone within the FBR (optionally being a zone defined vertically, radially, or based on another coordinate system), are individually controllable thereby to enable zone-specific heating or to ensure homogeneous heating of the process materials. This is optionally combined with internal sensors (for example zone-specific temperature sensors) and a control system which is configured to apply differential temperatures between the zones thereby to encourage modified fluid movement behaviours within the process materials. This may be used to achieve functions including optimisation of temperature consistency and/or resolving of identified trends towards stratification of the process materials (e.g., by encouraging convection style movement).

In some embodiments, the process materials, such as methane, may be inserted at one or more insertion points in the FBR.

### Induction Heating

In this example, a magnetic field is generated via components extremally of the FBR cavity (for example using an electrically conductive coil through which an alternate current is passed), which causes current flow within the process materials to thereby heat the process materials based on the electrically conductive/resistive nature of the carbon. Additional detail regarding potential induction heating arrangements is provided further below. This provides a form of “internal heating”—in the sense that the heat is applied to process materials internally of the reactor sidewalls—using infrastructure external of the reactor sidewalls. In that regard, the electrically conductive carbon within the process materials in essence serves as an internal heating element.

It will be understood the eddy currents are induced in the conductive material.

In further embodiments, multiple FBR heating technologies and/or systems may be combined thereby to achieve objectives including the following: (i) consistent heating within the process materials; (ii) limiting of surface temperature of internal components within the FBR cavity, thereby to reduce risks of surface carbon deposition; (iii) zonal control thereby to encourage desired heating/convection/agitation effects.

### Example Control System Arrangement

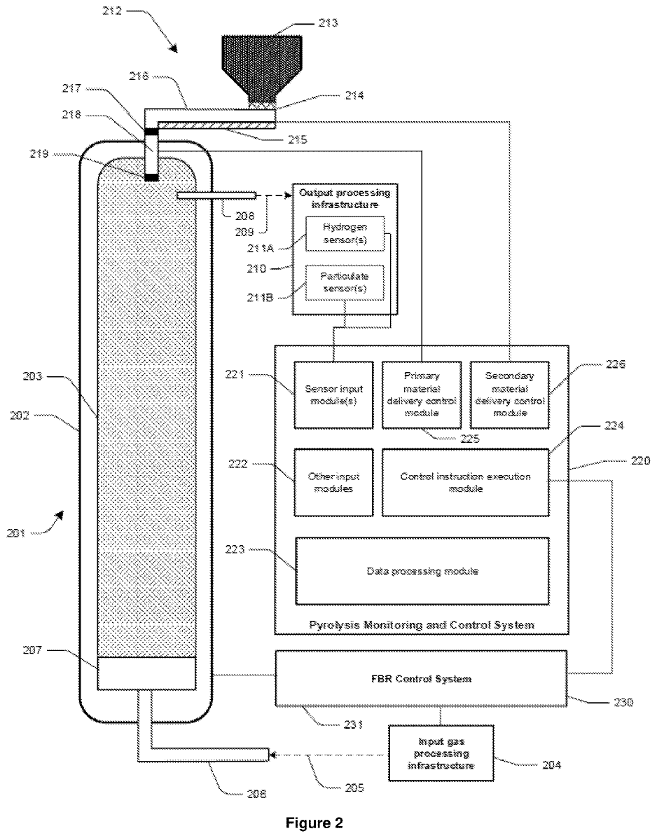

An example control system will now be described by reference to FIG. 2.

FIG. 2 illustrates selected components of an example pyrolysis system for the conversion of a hydrocarbon feedstock to hydrogen gas and graphitic carbon, which may be incorporated into and/or form part of the system of FIG. 1.

The pyrolysis system of FIG. 1 includes on a fluidised bed reactor (FBR) 201, Matters of detailed configuration and control of a FBR for the present purposes fall beyond the scope of the present disclosure. However, key components will be described.

FBR 201 has a body 202 which encapsulates a reactor chamber 203 in which a fluidised bed is maintained. In particular, input gas fluidising infrastructure 204 is configured to deliver a hydrocarbon supply 205 to a FBR input 206. FBR input 206 is coupled to FBR gas delivery components 207, which are configured to control delivery of hydrocarbon supply 205 into reactor chamber 203 and maintain homogeneous fluidisation of process materials contained therein.

FBR 201 includes heating infrastructure, configured to maintain the process materials within reactor chamber 203 at a predetermined temperature (which may be a predetermined average temperature). The nature of heating infrastructure is preferably Electrified bed heating, whereby one or more electrodes, for example including one or more pairs of electrodes, are positioned within the FBR, thereby to cause current flow from a first of the electrodes of a pair to the second electrode of that pair (optionally with a given electrode forming part of multiple pairs). In a preferred embodiment there are three electrodes, and alternating current is used. In such a configuration, there is a resultant flow of current through the electrically conductive carbon within the process materials, which increases in temperature dues to resistive qualities. As a result, the electrically conductive carbon in essence behaves as a resistive heating element (while in a homogenised fluidised state within the FBR), causing overall heating of the process materials.

Other forms of heating may also be used, with options including (but not being limited to) one or more of the following:
External resistive heating (hot wall), whereby heat is applied directly through sidewall of the FBR, for example via external resistive elements.
Internalresistive heating (cold wall), whereby heat is applied via elements which are disposed within the central reactor chamber of the FBR.
Induction heating, whereby a magnetic field is generated via components extremally of the FBR reactor chamber (for example using an electrically conductive coil through which an alternate current is passed), which causes current flow within the process materials to thereby heat the process materials based on the electrically conductive/resistive nature of the carbon. Additional detail regarding potential induction heating arrangements is provided further below. This provides a form of “internal heating”—in the sense that the heat is applied to process materials internally of the reactor sidewalls—using infrastructure external of the reactor sidewalls. In that regard, the electrically conductive carbon within the process materials in essence serves as an internal heating element.

In the illustrated example, FBR 201 is coupled to an FBR control system 230, which controls various operational parameters, such as operation of heating infrastructure, and control over gas release/fluidization components.

FBR 201 additionally includes an output assembly 208 which is configured to enable release of output process materials 209 to output processing infrastructure 210. For example, output processing infrastructure 210 may include various components for the separation of gasses and solids, separation of hydrogen gas from other gases, filtering and separation of solids, and support of other downstream operations.

The system includes a primary particulate matter delivery control system 212. The primary particulate matter delivery control system is configured to control metered delivery of primary particulate matter into the FBR 201. The precise nature (for example components and configuration) of system 212 vary between embodiments, and the arrangement illustrated in FIG. 1 is an example only intended to demonstrate certain functionalities.

As a core functionality, system 212 is configured to deliver a primary particulate material, a stockpile of which is optionally contained in a feed hopper 213, into the process materials of FBR 201. This delivery is facilitated via various components, preferably components which enable controlled metered delivery of the particulate material (for example based on volume and/or weight). The way in which this is achieved varies between embodiments, although as a common feature it is preferably to have electronically controllable components which enable computerised control over material delivery.

The primary particulate material may include a catalytic particulate material, a non-catalytic particulate material, or a combination of both. For example:
In an embodiment, the particulate material is a catalytic particulate material for methane pyrolysis within the fluidised bed reactor. In an embodiment, the catalytic particulate material is selected from the group comprising, a carbon material having encapsulated iron, iron ore, synthetic or naturally occurring iron oxide, or low quality iron oxide.
In an embodiment, the particulate material is a non-catalytic particulate material selected to facilitate methane pyrolysis within the fluidised bed reactor. Preferably this is a graphitic material, for example selected from naturally occurring or synthetic graphite, preferably flake graphite. Other forms of carbon may be used, although it is preferable for forms of electrically-conductive carbon may be used (for example where the fluidised bed reactor is heated via flow of current (applied and/or inducted) through electrically conductive materials in the fluidised bed reactor.

It will be appreciated that selection of particulate materials is a matter of design choice for a particular pyrolysis operation, and that delivery technologies described herein are agnostic in that regard. In some cases multiple hoppers are present, containing different materials which are made selectively available for a single FBR. For operation of the present embodiment, the reactor chamber requires a conductive particulate material for the purposes of heating; the primary particulate material delivered via system 212 may have the request conductivity properties, or alternately gain such conductivity properties when introduced to the reactor chamber (as is the case with iron oxide, which is reduced to iron and then becomes encapsulated in carbon thereby to increase particulate conductivity).

In the illustrated example, hopper 213 is coupled to a first material delivery control component 214, which controls delivery of primary particulate material from the hopper via a gravity-fed arrangement to a metering chamber 216. Metering chamber 216 includes a conveyor 215, which transports in a controlled manner participate material into a pre-pre-delivery chamber 218. Pre-delivery chamber 218 preferably has one or more sensors configured to measure a quantity of particulate material in (or passing through) chamber 218 (for example by reference to weight or volume). Chamber 218 (optionally in conjunction with chamber 216) is able to be pressurised thereby to prevent egress of process materials into chamber 218 from FBR reactor chamber 203. For example, a first seal 219 is maintained in a sealed configuration whilst chamber 218 is filled with a predetermined quantity of particulate material, chamber 218 is pressurised, and then seal 219 is opened with a seal 218 closed. In another embodiment, pressurisation occurs between seal 219 and component 214, allowing for ongoing metered delivery of the particulate material under influence of conveyor 215. These are only two possible arrangements of physical infrastructure of enabling controlled/metered delivery of particulate materials into the FBR via one or more a pressurised pre-delivery chambers.

FIG. 2 illustrates a system configured to enable optimisation of the pyrolysis process, in the form of a Pyrolysis Monitoring and Control System (PMCS) 220. PMCS 220 is preferably defined by one or more networked computing terminals which execute computer executable code (software instructions) thereby to deliver functionality of modules illustrated in FIG. 2 and described below. A key function of PMCS 220 is controlling delivery of particulate material into the reactor chamber of FBR 201. Other functions are also optionally performed, for example as described further below.

Software executing at the PMCS 220 is described by reference to a plurality or “modules”. The term “module” refers to a software component that is logically separable (a computer program), or a hardware component. The module of the embodiment refers to not only a module in the computer program but also a module in a hardware configuration. The discussion of the embodiment also serves as the discussion of computer programs for causing the modules to function (including a program that causes a computer to execute each step, a program that causes the computer to function as means, and a program that causes the computer to implement each function), and as the discussion of a system and a method. For convenience of explanation, the phrases “stores information,” “causes information to be stored,” and other phrases equivalent thereto are used. If the embodiment is a computer program, these phrases are intended to express “causes a memory device to store information” or “controls a memory device to cause the memory device to store information.” The modules may correspond to the functions in a one-to-one correspondence. In a software implementation, one module may form one program or multiple modules may form one program. One module may form multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the embodiment. Even after a process in the embodiment has started, the term “predetermined” refers to something that is decided in advance of a process of interest depending on a condition or a status of the embodiment at the present point of time or depending on a condition or status heretofore continuing down to the present point of time. If “predetermined values” are plural, the predetermined values may be different from each other, or two or more of the predetermined values (including all the values) may be equal to each other. A statement that “if A, B is to be performed” is intended to mean “that it is determined whether something is A, and that if something is determined as A, an action B is to be carried out”. The statement becomes meaningless if the determination as to whether something is A is not performed.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a random-access memory (RAM), an external storage medium, a memory device connected via a communication network, and a ledger within a CPU (Central Processing Unit).

PMCS 220 includes one or more modules configured for receiving input data from a sensor or sensors configured to monitor output of FBR 201. In the illustrated example this includes a sensor input module 221, which is configured to receive data from a hydrogen sensor 211a which monitors hydrogen in the output feed from FBR 201, and a particulate sensor 211b which monitors metrics of particulate output from FBR 201 (for example as discussed further above). Sensor input module 221 is configured to process that input thereby to determine one or more parameters representative of hydrogen and/or particulate output from the fluidised bed reactor output (for example any one or more of: hydrogen throughput as a function of time and proportion of output gas/material which is defined by hydrogen, particle sizes/morphologies, particulate throughput quantities, and other parameters).

The PMCS includes a component which operates as control optimisation module which is responsive to the one or more parameters representative of fluidised bed reactor output for generating one or more control instructions. In the illustrated example this is provided as a functionality of a control optimisation module 223. In this regard, processing module 223 is configured to apply one or more algorithms (or other computerised processes) thereby to receive input including data representative of the one or more parameters representative of hydrogen output, and from those algorithms output data representative of instructions for controlling system 212 (and optionally other controllable components in the broader pyrolysis system). For example, based on input including a level of detected hydrogen, module 212 outputs data representative of an instruction to perform one or more of the following:
Increase a rate at which the particulate material is delivered to the FBR.
Increase a rate at which the particulate material is delivered to the FBR.
Deliver a predefined size batch of particulate material to the FBR at a defined time (the defined time may be scheduled or in essence “immediate”.
Where there are multiple hoppers 213 containing different particulate materials, switch between particulate materials and/or adjust ratios of different particulate materials.

Module 212 may also provide control instructions for other components, for example FBR control system 230 (for example to provide instructions in relation to heating, for example temperature setpoints, instructions relating to fluidisation parameters, and the like). In some embodiments module 212 is configured to directly control heating and/or fluidization infrastructure.

A control instruction delivery module 224 is configured to apply control instructions defined by processing module 224, which in the illustrated example involves delivery of control instructions to delivery system 212. Module 224 preferably executes based on a plurality of predefined rules which enable an algorithmic decision relating to whether or not (and optionally when) to implement a control instruction, for example based on safety and other factors. For example, module 224 may have access to data including availability of materials in hopper 212, scheduling for shutdowns and other operations, inputs from other sensors in the broader system, and the like.

In the illustrated example control instruction execution module 224 interacts with a primary material delivery module 225 and a secondary material delivery module 226 thereby to give physical real-world effect to control instructions. The former accesses controllable components associated with chamber 218 (for example valves, sensors, pressurisation components and the like) and the latter accesses controllable components associated with chamber 216 (for example component 214 and other valves, sensors, pressurisation components and the like). This is an example only; the manner by which modules within control system 220 provide control instructions to components within system 212 varies between embodiments dependent on the specific nature of system 212 and its operation. This may range significantly in complexity (for example from a simple embodiment where system 212 is able to receive instructions referencing particulate material release rates, to complex embodiments where was constituent controller within system 212 requires individual control/actuation).

The control instructions generated by control optimisation module 224 and executed via execution module 224 may, in further embodiments, relate to components other than those belonging to system 12. For example, system 220 includes other input modules 220 for receiving data from other sensors associated with the FBR or other pyrolysis system components, and data inputs from other sources (for example desired operational characteristics, scheduled operation factors such as shutdowns, and the like. That is, PMCS 220 additionally (as an optional feature) includes other input modules 222, which are configured to monitor other outputs and/or operational parameters of FBR 201. This may include any one or more of the following:
Input derived from a sensor configured to monitor temperature within the fluidised bed reactor.
Input representative of a predicted future temperature within the fluidised bed reactor.
Input representative of one or more parameters derived from monitoring of particulate matter detected in the fluidised bed reactor output (for example carbon purity, carbon morphology, particle size, and the like).
Input representative of one or more desired parameters relating to particulate matter detected in the fluidised bed reactor output (for example carbon purity, carbon morphology, particle size, and the like).
Input representative of one or more desired parameters relating to hydrogen output.
Input representative of one or more input gas delivery parameters.
Input representative of desired future operating conditions for the fluidised bed reactor (for example a planned shutdown).
Input representative of one or more parameters relating to gasses other than hydrogen detected in the fluidised bed reactor output.

Furthermore, as noted, modules 223 and 224 may be configured to additionally/alternately generate and execute control instructions for components other than those of system 12 (optionally including FBR components such as heating infrastructure, and/or other components in the broader pyrolysis system).

The manner by which processing module 223 operates varies between embodiments based on a range of factors (for example FBR size/shape, facility purpose, input gas parameters, catalyst/non-catalytic material properties, and so on). In a broad sense, the following approaches may optionally be used:
A rules-based algorithmic approach, whereby logical rules are generated to equate predefined inputs (for example hydrogen throughput rates, desired output carbon morphologies, and other desired operational parameters) to control instructions.
An AI/machine learning driven approach whereby a software module is trained based on training data to receive inputs (for example hydrogen throughput rates, desired output carbon morphologies, and other desired operational parameters) and perform AI/machine learning based processing to deliver an output representative of a control instruction. For example, a neural network may be trained based on input data collected from historical operation of one or more similar methane pyrolysis systems, the training data including components representative of particulate matter deliver (e.g. catalyst delivery) into the FBR along with past/future time series data representative of operational parameters (such as hydrogen throughput). This may be used, again as a representative example, to train a neural network to receive as input current data representative of FBR operation, including hydrogen throughput, and provide output representative of an amount of particulate material (e.g. known catalytic material) to deliver to the FBR thereby to result in maximised hydrogen throughput. Such neural networks may also be trained thereby to enable control over carbon morphologies generated in the FBR (although in that context control over FBR temperature is relevant in addition to control over particulate delivery rates).

In the case of the latter, there is preferably ongoing generation of training data thereby to facilitate ongoing learning and optimisation of control for a specific pyrolysis system over the course of its operation.

### Example Control Rules

Set out below are several example control rules which may be implemented via the system of FIG. 2, and/or via processes/methods described herein. These may be implemented in combination.
If hydrogen output is below a threshold, generate instruction to perform one-off insertion of defined quantity of primary particulate material.
If hydrogen output is below a threshold, generate instruction to increase rate insertion of primary particulate material.
If hydrogen output is below a threshold, generate instruction to increase temperature target for reactor chamber.
If hydrogen output is below a threshold, generate instruction to increase current to reactor chamber electrodes.
If hydrogen output is below a threshold, generate instruction to adjust degree of agitation/fluidization in reactor.
If particulate material output is below a threshold, generate instruction to perform one-off insertion of defined quantity of primary particulate material.
If particulate material output is below a threshold, generate instruction to increase rate insertion of primary particulate material.
If particulate material output is below a threshold, generate instruction to increase temperature target for reactor chamber.
If particulate material output is below a threshold, generate instruction to increase current to reactor chamber electrodes.
If particulate material output is below a threshold, generate instruction to adjust degree of agitation/fluidization in reactor.
If particulate material average size from output is above a threshold, generate instruction to perform one-off insertion of defined quantity of primary particulate material.
If particulate material average size from output is above a threshold, generate instruction to increase/decrease rate insertion of primary particulate material.
If particulate material average size from output is above a threshold, generate instruction to increase/decrease temperature target for reactor chamber.
If particulate material average size from output is above a threshold, generate instruction to increase/decrease current to reactor chamber electrodes.
If particulate material average size from output is above a threshold, generate instruction to adjust degree of agitation/fluidization in reactor.
If particulate material morphology in output is outside of defined target range, generate instruction to perform one-off insertion of defined quantity of primary particulate material.
If particulate material morphology in output is outside of defined target range, generate instruction to increase/decrease rate insertion of primary particulate material.
If particulate material morphology in output is outside of defined target range, generate instruction to increase/decrease temperature target for reactor chamber.
If particulate material morphology in output is outside of defined target range, generate instruction to increase/decrease current to reactor chamber electrodes.
If particulate material morphology in output is outside of defined target range, generate instruction to adjust degree of agitation/fluidization in reactor.

It will be appreciated that these are examples only, and that in practice optimisation and/or machine learning techniques are optionally used to configure processing logic to optimise pyrolysis performance based on one or more target parameter values.

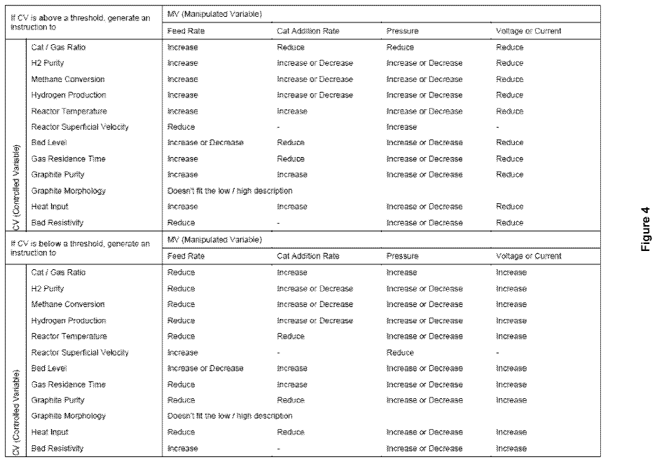

FIG. 4 provides additional detail in relation to relationships between example controlled variables and manipulated variables, in the context of where the controlled variables are above or below defined thresholds. In this example, the controlled variables are as follows:
Catalyst to gas ratio in reactor chamber.
Hydrogen purity in output.
Methane (or other hydrocarbon) conversion.
Hydrogen production.
Reactor chamber temperature.
Reactor superficial velocity (for particulates).
Bed level in FBR.
Gas residence time in reactor chamber.
Graphite purity in reactor output.
Graphite morphology in reactor output.
Heat input to reactor chamber.
Bed resistivity in reactor chamber.

The example manipulated variables are as follows:
Feed rate: the rate at which a gaseous hydrocarbon feed is provided to the reactor.
Catalyst addition rate: the rate at which catalysis (i.e. the primary particulate material) is provided into the reactor chamber.
Pressure in the reactor chamber.
Voltage and/or current being applied to heating electrodes.

The table of FIG. 4 provides representation of example relationships between the controlled variables and manipulated variables. The control technology described herein is configured to control some or all of the manipulated variables (directly and/or indirectly), based on measured and/or target values for some or all of the controlled variables. For example this may be facilitated by application of known technologies such as DMC (Dynamic Matrix Control) and/or RTO (Real Time Optimization). DMC is a multi-variable optimization software program that sits on top of regulatory control and pushes variables in a direction based on a predefined set of relationships between variables & prioritization inputs. RTO is a fundamental chemical engineering-based model that adjusts limits in the DMC and priorities based on economic optimization signals, and understanding of process optima (DMC does not account for optima; it is constraint based). Alternately, other proprietary software approaches may be implemented.

From the table of FIG. 4, the following example control instructions may may be derived:
If catalyst-to-gas Ratio is above a threshold, generate an instruction to Increase Feed Rate
If Hydrogen purity is above a threshold, generate an instruction to Increase Feed Rate
If Methane Conversion is above a threshold, generate an instruction to Increase Feed Rate
If Hydrogen Production is above a threshold, generate an instruction to Increase Feed Rate
If Reactor Temperature is above a threshold, generate an instruction to Increase Feed Rate
If Reactor Superficial Velocity is above a threshold, generate an instruction to Reduce Feed Rate
If Bed Level is above a threshold, generate an instruction to Increase or Decrease Feed Rate
If Gas Residence Time is above a threshold, generate an instruction to Increase Feed Rate
If Graphite Purity is above a threshold, generate an instruction to Increase Feed Rate
If Heat Input is above a threshold, generate an instruction to Increase Feed Rate
If Bed Resistivity is above a threshold, generate an instruction to Reduce Feed Rate
If catalyst-to-gas Ratio is above a threshold, generate an instruction to Reduce Catalyst Addition Rate (i.e. primary particulate material addition rate)
If Hydrogen purity is above a threshold, generate an instruction to Increase or Decrease Catalyst Addition Rate (i.e. primary particulate material addition rate)
If Methane Conversion is above a threshold, generate an instruction to Increase or Decrease Catalyst Addition Rate (i.e. primary particulate material addition rate)
If Hydrogen Production is above a threshold, generate an instruction to Increase or Decrease Catalyst Addition Rate (i.e. primary particulate material addition rate)
If Reactor Temperature is above a threshold, generate an instruction to Increase Catalyst Addition Rate (i.e. primary particulate material addition rate)
If Reactor Superficial Velocity is above a threshold, generate an instruction to—Catalyst Addition Rate (i.e. primary particulate material addition rate)
If Bed Level is above a threshold, generate an instruction to Reduce Catalyst Addition Rate (i.e. primary particulate material addition rate)
If Gas Residence Time is above a threshold, generate an instruction to Reduce Catalyst Addition Rate (i.e. primary particulate material addition rate)
If Graphite Purity is above a threshold, generate an instruction to Increase Catalyst Addition Rate (i.e. primary particulate material addition rate)
If Heat Input is above a threshold, generate an instruction to Increase Catalyst Addition Rate (i.e. primary particulate material addition rate)
If Bed Resistivity is above a threshold, generate an instruction to—Catalyst Addition Rate (i.e. primary particulate material addition rate)
If catalyst-to-gas Ratio is above a threshold, generate an instruction to Reduce Pressure
If Hydrogen purity is above a threshold, generate an instruction to Increase or Decrease Pressure
If Methane Conversion is above a threshold, generate an instruction to Increase or Decrease Pressure
If Hydrogen Production is above a threshold, generate an instruction to Increase or Decrease Pressure
If Reactor Temperature is above a threshold, generate an instruction to Increase or Decrease Pressure
If Reactor Superficial Velocity is above a threshold, generate an instruction to Increase Pressure
If Bed Level is above a threshold, generate an instruction to Increase or Decrease Pressure
If Gas Residence Time is above a threshold, generate an instruction to Increase or Decrease Pressure
If Graphite Purity is above a threshold, generate an instruction to Increase or Decrease Pressure
If Heat Input is above a threshold, generate an instruction to Increase or Decrease Pressure
If Bed Resistivity is above a threshold, generate an instruction to Increase or Decrease Pressure
If catalyst-to-gas Ratio is above a threshold, generate an instruction to Reduce Voltage or Current
If Hydrogen purity is above a threshold, generate an instruction to Reduce Voltage or Current
If Methane Conversion is above a threshold, generate an instruction to Reduce Voltage or Current
If Hydrogen Production is above a threshold, generate an instruction to Reduce Voltage or Current
If Reactor Temperature is above a threshold, generate an instruction to Reduce Voltage or Current
If Reactor Superficial Velocity is above a threshold, generate an instruction to—Voltage or Current
If Bed Level is above a threshold, generate an instruction to Reduce Voltage or Current
If Gas Residence Time is above a threshold, generate an instruction to Reduce Voltage or Current
If Graphite Purity is above a threshold, generate an instruction to Reduce Voltage or Current
If Heat Input is above a threshold, generate an instruction to Reduce Voltage or Current
If Bed Resistivity is above a threshold, generate an instruction to Reduce Voltage or Current
If catalyst-to-gas Ratio is above a threshold, generate an instruction to Reduce Feed Rate
If Hydrogen purity is above a threshold, generate an instruction to Reduce Feed Rate
If Methane Conversion is above a threshold, generate an instruction to Reduce Feed Rate
If Hydrogen Production is above a threshold, generate an instruction to Reduce Feed Rate
If Reactor Temperature is above a threshold, generate an instruction to Reduce Feed Rate
If Reactor Superficial Velocity is above a threshold, generate an instruction to Increase Feed Rate
If Bed Level is above a threshold, generate an instruction to Increase or Decrease Feed Rate
If Gas Residence Time is above a threshold, generate an instruction to Reduce Feed Rate
If Graphite Purity is above a threshold, generate an instruction to Reduce Feed Rate
If Heat Input is above a threshold, generate an instruction to Reduce Feed Rate
If Bed Resistivity is above a threshold, generate an instruction to Increase Feed Rate
If catalyst-to-gas Ratio is above a threshold, generate an instruction to Increase Catalyst Addition Rate (i.e. primary particulate material addition rate)
If Hydrogen purity is above a threshold, generate an instruction to Increase or Decrease Catalyst Addition Rate (i.e. primary particulate material addition rate)
If Methane Conversion is above a threshold, generate an instruction to Increase or Decrease Catalyst Addition Rate (i.e. primary particulate material addition rate)
If Hydrogen Production is above a threshold, generate an instruction to Increase or Decrease Catalyst Addition Rate (i.e. primary particulate material addition rate)
If Reactor Temperature is above a threshold, generate an instruction to Reduce Catalyst Addition Rate (i.e. primary particulate material addition rate)
If Reactor Superficial Velocity is above a threshold, generate an instruction to—Catalyst Addition Rate (i.e. primary particulate material addition rate)
If Bed Level is above a threshold, generate an instruction to Increase Catalyst Addition Rate (i.e. primary particulate material addition rate)
If Gas Residence Time is above a threshold, generate an instruction to Increase Catalyst Addition Rate (i.e. primary particulate material addition rate)
If Graphite Purity is above a threshold, generate an instruction to Reduce Catalyst Addition Rate (i.e. primary particulate material addition rate)
If Heat Input is above a threshold, generate an instruction to Reduce Catalyst Addition Rate (i.e. primary particulate material addition rate)
If Bed Resistivity is above a threshold, generate an instruction to—Catalyst Addition Rate (i.e. primary particulate material addition rate)
If catalyst-to-gas Ratio is above a threshold, generate an instruction to Increase Pressure
If Hydrogen purity is above a threshold, generate an instruction to Increase or Decrease Pressure
If Methane Conversion is above a threshold, generate an instruction to Increase or Decrease Pressure
If Hydrogen Production is above a threshold, generate an instruction to Increase or Decrease Pressure
If Reactor Temperature is above a threshold, generate an instruction to Increase or Decrease Pressure
If Reactor Superficial Velocity is above a threshold, generate an instruction to Reduce Pressure
If Bed Level is above a threshold, generate an instruction to Increase or Decrease Pressure
If Gas Residence Time is above a threshold, generate an instruction to Increase or Decrease Pressure
If Graphite Purity is above a threshold, generate an instruction to Increase or Decrease Pressure
If Heat Input is above a threshold, generate an instruction to Increase or Decrease Pressure
If Bed Resistivity is above a threshold, generate an instruction to Increase or Decrease Pressure
If catalyst-to-gas Ratio is above a threshold, generate an instruction to Increase Voltage or Current
If Hydrogen purity is above a threshold, generate an instruction to Increase Voltage or Current
If Methane Conversion is above a threshold, generate an instruction to Increase Voltage or Current
If Hydrogen Production is above a threshold, generate an instruction to Increase Voltage or Current
If Reactor Temperature is above a threshold, generate an instruction to Increase Voltage or Current
If Reactor Superficial Velocity is above a threshold, generate an instruction to—Voltage or Current
If Bed Level is above a threshold, generate an instruction to Increase Voltage or Current
If Gas Residence Time is above a threshold, generate an instruction to Increase Voltage or Current
If Graphite Purity is above a threshold, generate an instruction to Increase Voltage or Current
If Heat Input is above a threshold, generate an instruction to Increase Voltage or Current
If Bed Resistivity is above a threshold, generate an instruction to Increase Voltage or Current

Again, it should be appreciated that these are examples only.

### Example Electrified Bed Heating Configuration

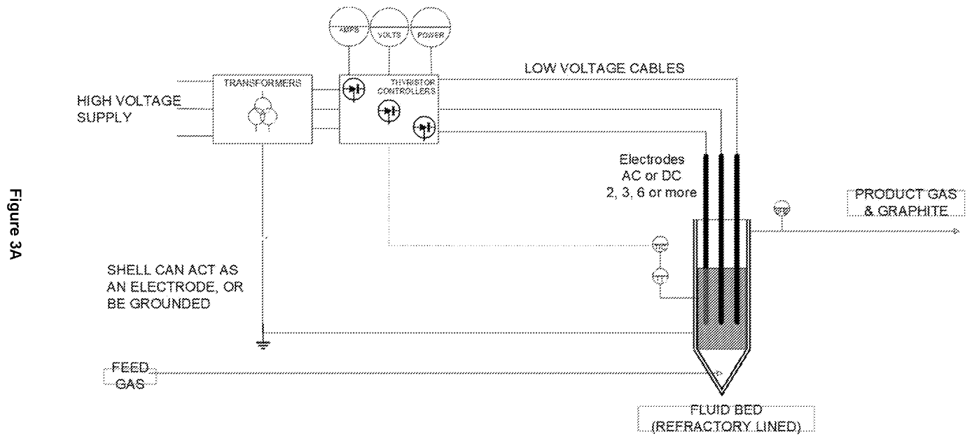

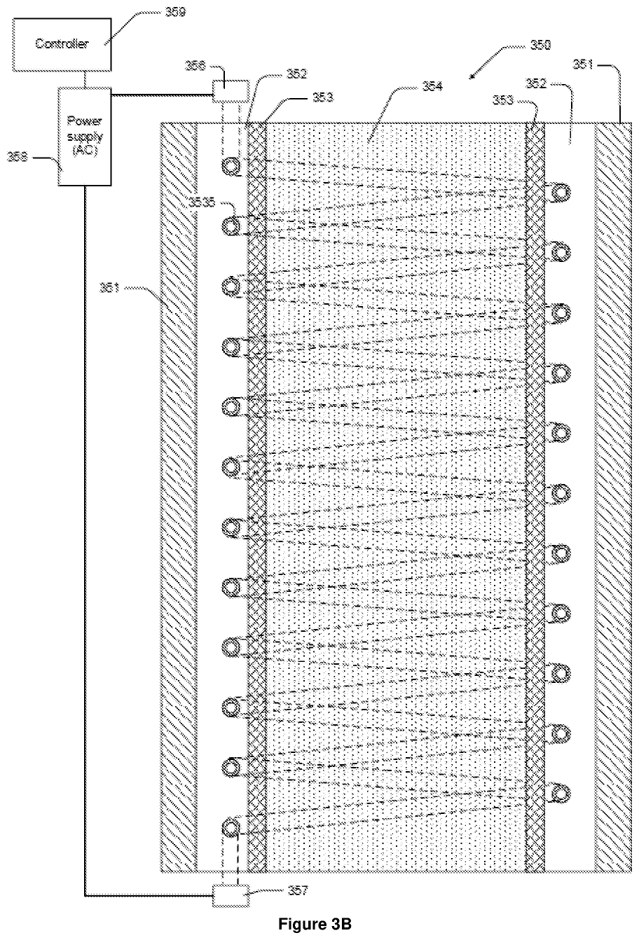

FIG. 3A illustrates a view of a system 300 including a FBR with induction heating configured to operate in conjunction with methane pyrolysis as disclosed the example of FIG. 1.

In this example, a refractory lined FBR 301 has three electrodes (302A-C) which extend into the reactor chamber, such that they are exposed within the fluidised bed of hydrocarbon gas and particulate materials (including conductive particulates). Current flowing between the electrodes is in this manner conducted through the conductive particulates, causing them to heat up, and thereby heating the entire contents of the reactor chamber as a result of conductivity and fluidization.

Although three electrodes are shown, there may be other numbers, and the positions may vary between embodiments. In some embodiments the FBR shell is used as a further electrode.

In operation, a high voltage power supply 310 operates in conjunction with transformers 311 and thyristor controllers 312 (for current, voltage and power). The thyristor controllers are operated with an alternating voltage in single-phase or three-phase. This is passed through low voltage cables to deliver the current across the electrodes, optionally as AC or DC (depending on implementation selections).

In use, a feed gas supply 314 delivers hydrocarbon to FBR 301. A particular material supply system (not shown), such as that of FIG. 2, delivers a controlled/metered supply of particulate material, which serves as a catalyst for hydrocarbon pyrolysis in the FBR. An output 315 of product gas (including hydrogen) and particulate material (including graphite) is released from the FBR.

### Example Induction Heating Configuration

FIG. 3B illustrates a simplified sectional view of a system 350 including a FBR with induction heating configured to operate in conjunction with methane pyrolysis as disclosed the example of FIG. 1.

System 350 includes a sidewall 351, which is preferably cylindrical and formed of a robust material selected from the group comprising metal, such as steel. The height of the sidewall may vary between embodiments. Inward of the sidewall is a sidewall cavity 352, and a refractory reactor housing 353 (for example a silica refractory material suitable to insulate the sidewall from excess heat and to also encapsulate/support the electrically conductive coil) which defines a central cavity 354 in which a fluidised bed is maintained (fluidising components are not illustrated).

Cavity 354 has a plurality of connection ports which are not shown, including: (i) at least one first inlet for delivery of a feed gas containing a hydrocarbon gas, such as methane (not shown), preferably at or adjacent a lower end (ii) a second inlet for delivery of a feed of starting material, such as a graphitic material, Hazer graphite, an iron containing catalyst (for example iron ore or synthetic iron oxide), preferably at or adjacent an upper end; and (iii) an outlet for release of process materials, which comprise particulates (including carbon) and gas (including hydrogen). The coil may also be embedded within the refractory.

An electrically conductive coil 355 is housed within sidewall cavity 352, such that the coil is disposed adjacent refractory reactor housing 353. This coil is configured to carry an alternating current, delivered via a high frequency power supply 358 and input/output connections 356 and 357. This coil includes a central cavity through which a coolant is configured to flow (for example water), thereby to prevent the coil from reaching undesirable temperatures in use. The coil is spaced apart from steel sidewall 351 by a threshold distance to prevent inductive heating of the sidewall (this distance will vary between embodiments and be selected depending on factors including overall system dimensions and current throughput parameters). In some embodiments, the system comprises a plurality of electrically conductive coils. In some embodiments, each of the plurality of electrically conductive coils are independently operable.

An alternating current being transmitted through coil 355 causes induction within the process materials, resulting in electrical current transmitting throughout electrically conductive carbon particles in the process materials. Electrical resistance in the carbon particles causes heating of those particles, and hence heating of the process materials as a whole. This allows the process materials to be brought up to and maintained within a desired temperature range of between about 600 to 1500 degrees.

Preferably, one or more temperature sensors are configured to monitor temperature within the process materials that are fluidised within central cavity 354, and deliver temperature data to a controller 359. Controller 359 executes software instructions which are configured to cause controlling of high frequency power supply 358 based on temperature sensor data, thereby to maintain the process materials within the desired temperature range.

Use of induction heating in the context of the present fluidised bed methane pyrolysis reaction is particularly advantageous, as unlike other heating options described above, induction heating avoids presence of components/regions at which local surface temperatures reach a level where carbon deposition occurs.

In some cases, the manner by which controlled heating of process materials in a reactor, particularly a fluidised bed reactor, is used to enable process improvements. This enables a range of advantages, discussed below, including (but not limited to) mitigation of issues relating to unwanted carbon surface deposition, an ability to adjust catalytic inputs, control over residence time, and control over products' (such as carbon, particularly graphitic carbon in various morphologies, and hydrogen) purity. Other advantages may include larger scaling capability, better temperature control, simpler construction, enhanced energy efficiency.

Generally, the underlying pyrolysis method comprises a method for hydrocarbon gas pyrolysis, the method comprising: providing into a fluidised bed reactor an initial feedstock of an electrically conductive carbon material; commencing operation of the fluidised bed reactor, wherein the fluidised bed reactor is fed by an input of the hydrocarbon gas; operating power supply thereby to deliver current (via control of current and/or voltage) to one or more electrodes and/or electrically conductive coil, thereby to cause heating of electrically conductive carbon material to a predetermined temperature that initiates and maintains pyrolysis of the hydrocarbon gas; and operating an outlet component thereby to release process materials from the fluidised bed reactor, wherein the released process materials include carbon materials, unreacted hydrocarbon gas and/or hydrogen gas.

The hydrocarbon gas may be any gas stream that comprises light hydrocarbons. Illustrative examples of hydrocarbon gas include, but are not limited to, natural gas, coal seam gas, landfill gas and biogas. The composition of the hydrocarbon gas may vary significantly but it will generally comprise one or more light hydrocarbons from a group comprising methane, ethane, ethylene, propane and butane. In a preferred embodiment, the hydrocarbon gas is selected from the group comprising methane, ethane, ethylene, propane and/or butane or mixtures thereof. In a preferred embodiment, the hydrocarbon gas consists essentially of one of methane, ethane, ethylene, propane or butane, preferably methane.

In a preferred embodiment, the hydrocarbon gas is natural gas.

In a preferred embodiment, hydrocarbon gas is biogas.

In a preferred embodiment, hydrocarbon gas is substantially comprised of methane.

The outlet component may be operated controllably or without control. In one embodiment, it is uncontrolled (the flow of solids from the reactor being an outcome of particle elutriation). The rate of elutriation will therefore be a function of geometry and overall design. Other means of operating the outlet component are contemplated.

In one form of the invention, the FBR is operated above atmospheric pressure. In one form of the present invention, FBR is operated at a pressure of between about 0 bar to 100 bar. Preferably, the pressure is between about 0 bar to 50 bar. More preferably, the pressure is between 0 bar and 20 bar. Still preferably, the pressure is between about 2 bar and 10 bar.

In one form of the present invention, the predetermined temperature is between about 600° C. and 1500° C. Preferably, the predetermined temperature is between about 600° C. and 1200° C. More preferably, the predetermined temperature is between about 800° C. and 1200° C. Still preferably, the predetermined temperature is about 900° C. Still preferably, the predetermined temperature is about 1000° C. Still preferably, the predetermined temperature is about 1100° C. Still preferably, the predetermined temperature is about 1200° C.

In one form of the present invention, the average temperature is between about 600° C. and 1500° C. Preferably, the average temperature is between about 600° C. and 1200° C. More preferably, the average temperature is between about 800° C. and 1200° C. Still preferably, the average temperature is about 900° C. Still preferably, the average temperature is about 1000° C. Still preferably, the average temperature is about 1100° C. Still preferably, the average temperature is about 1200° C.

In an embodiment, the graphitic starting material has a purity of greater than about 95% w/w. Preferably, the graphitic starting material has a purity of greater than about 99% w/w. More preferably, the graphitic starting material has a purity of greater than about 99.5% w/w. Most preferably, the graphitic starting material has a purity of greater than about 99.9% w/w.

In an embodiment, the graphitic starting material has a purity of about 50% w/w. Preferably, the graphitic starting material has a purity of greater than about 60% w/w. More preferably, the graphitic starting material has a purity of greater than about 70.5% w/w. Most preferably, the graphitic starting material has a purity of greater than about 80% w/w.

In an embodiment, the regenerated graphite material has a purity of greater than about 95% w/w. Preferably, the regenerated graphite material has a purity of greater than about 99% w/w. More preferably, the regenerated graphite material has a purity of greater than about 99.5% w/w. Most preferably, the regenerated graphite material has a purity of greater than about 99.9% w/w.

In one form of the present invention, the iron containing catalyst is a synthetic metal-containing catalyst. Throughout this specification, unless the context requires otherwise, the term “synthetic” will be understood to imply that the material has been synthesised through chemical techniques. Synthetic metal-containing catalysts are typically of high purity.

In one form of the present invention, the synthetic iron-containing catalyst is a synthetic iron oxide-containing material. In one form of the present invention, the iron oxide is synthetic metal-containing catalyst is Fe₂O₃ or Fe₃O₄.

In an alternative form of the present invention, the iron-containing catalyst is non-synthetic. Throughout this specification, unless the context requires otherwise, the term “non-synthetic” will be understood to imply that the material has not been synthesised through chemical techniques. Whilst the term “non-synthetic” does include naturally occurring materials, it should not be understood to exclude materials that have gone through physical beneficiation such as crushing and screening or classification.

In one form of the present invention, the iron-containing catalyst is a non-synthetic iron oxide-containing material. In one form of the present invention, the iron-containing catalyst is a non-synthetic iron oxide-containing ore. In one form of the present invention, the non-synthetic iron oxide-containing ore is iron ore. The iron ore may be hematite iron ore or goethite iron ore. The iron ore may be low grade iron ore.

In one form of the present invention, the iron-containing catalyst may undergo a pre-treatment step to increase its catalytic effect. Pre-treatment steps may include prereduction at high temperatures. Advantageously, the inventors have discovered that the present invention may obviate such a pre-treatment step.

As would be understood by a person skilled in the art, graphitic material can exist in many forms, such as:
graphitic fibres, which are fibrous carbon structures typically ranging from 100 nm to 100 microns in length, carbon nano-tubes (CNTs), which are cylindrical nano-structures comprising single or multiple graphitic sheets aligned concentrically or perpendicular to a central axis also fall within the scope of graphitic fibres;
carbon nano-onions (CNOs), which are structures that consist of multiple spherical graphitic sheets that are concentrically layered from a central core, which is typically a catalyst particle or a void. These carbon structures typically range from 50-500 nm in diameter;
carbon micro-spheres (CMSs), which are hollow globular graphitic structures typically greater than 500 nm in size. They are globular in shape and can be chain-like. The synthetic form of this graphite morphology is novel, having only been found naturally occurring in meteorites; and
graphene, which is single-layer or single-digit layer sheets of graphite.

In an embodiment, the carbon materials are selectively synthesised to be substantially of one or more of a desired morphology. In a preferred form of the present invention, the desired morphology is selected from the group comprising graphite fibres, carbon nano-onions (CNOs), carbon micro-shells (CMSs) and graphene. More preferably, the graphite fibres comprise a mixture of carbon nanotubes (CNTs) and other graphitic fibres. In a preferred form of the present invention, the desired morphology is selected from one or more of the group comprising graphite fibres, carbon nano-onions (CNOs), carbon micro-shells (CMSs) and graphene. In an embodiment, the desired morphology is substantially comprised of graphite fibres. In an embodiment, the desired morphology is substantially comprised of carbon nano-onions (CNOs). In an embodiment, the desired morphology is substantially comprised of carbon micro-shells (CMSs). In an embodiment, the desired morphology is substantially comprised of graphene.

The use of current-based heating of the FBR allows for multiple reaction pathways, expanding beyond the use of an iron ore catalyst as described in relation to FIG. 1 These are as follows:
(1) Utilising a feedstock of carbon having embedded iron, in conjunction with an iron ore catalyst. The iron ore catalysis enables the pyrolysis reaction to occur at a relatively lower temperature (for example around 900 degrees), with carbon growing on iron ore particles. The iron ore catalysis requires continuous or periodically replenishing, as although the catalyst is not consumed in the reaction, it does become contained within carbon and is removed from the reactor within extracted carbon particles.
(2) Utilising a feedstock of carbon having embedded iron, in conjunction with an iron ore catalyst. The iron ore catalysis enables the pyrolysis reaction to occur at a relatively lower temperature (for example around 900 degrees), with carbon growing on iron ore particles. The iron ore catalysis requires continuous or periodically replenishing, as although the catalyst is not consumed in the reaction, it does become contained within carbon and is removed from the reactor within extracted carbon particles.
(3) Utilising a feedstock of graphite at initiation of the reaction, and operating the reaction at a high-temperature non-catalytic state. For example, induction heating may be used to elevate process material temperatures to over 1000 degrees, preferably over 1,100 degrees. In this state, hydrocarbon feed gas breaks down into hydrogen and carbon, with the carbon growing on the flake graphite feedstock. The resulting large carbon particles are extracted along with output process materials, and preferably; at least a portion of this is processed back into graphite feedstock material, for reintroduction into the reactor. A control system is configured to input additional graphite feedstock material into the reactor on either a continuous or periodic basis, thereby to provide a substrate on which carbon can be deposited in the pyrolysis reaction.

The latter option has benefits in the sense that the reaction itself is able to produce an ongoing supply of graphite feedstock material, and the level of purity of carbon extracted from the FBR can be maintained at extremely high levels.

In some embodiments, the system or method of the invention comprises a plurality of reactors. In some embodiments, the plurality of reactors are arranged in series or in parallel.

### CONCLUSIONS AND INTERPRETATION

It will be appreciated that the disclosure above provides useful improvements in the context of methane pyrolysis technologies.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The claims defining the invention are as follows:

1. A method for controlling a hydrocarbon gas pyrolysis system, wherein the hydrocarbon gas pyrolysis system includes a reactor subsystem having a reactor chamber in which a hydrocarbon gas is decomposed in presence of a conductive particulate material, the method comprising:
receiving time series input data from a reactor output sensor system provided by the hydrocarbon gas pyrolysis system, wherein the reactor output sensor system is configured to monitor composition of a reactor output that is released from the reactor subsystem;
processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
operating a control optimisation module to process data including the one or more parameters representative of real-time reactor subsystem output based on computer executable code, thereby to generate one or more control instructions; and
operating a control module thereby to deliver the one or more control instructions to effect control over at least one of:
(i) a heating control system, wherein the heating control system controls a level of current and/or voltage applied to one or more electrodes which are configured to deliver a current into the reactor chamber such that the current is propagated through the conductive particulate material; and
(ii) a particulate matter delivery control system, wherein the particulate matter delivery control system is configured to control metered delivery of a primary particulate material into the reactor chamber.

2. A method according to claim 1 wherein the one or more parameters relate to each of: (i) a measure of hydrogen gas in the reactor output; and (ii) a measure of the one or more particulate materials in the reactor output.

3. A method according to claim 1 wherein the one or more parameters relate to a measure of hydrogen gas in the reactor output.

4. A method according to claim 1 wherein the one or more parameters relate to a measure of one or more particulate materials in the reactor output.

5. A method according to any one of claims 1-4 wherein the one or more control instructions effect control over each of the heating control system and the particulate matter delivery control system.

6. A method according to any one of claims 1-4 wherein the one or more control instructions effect control over heating control system.

7. A method according to any one of claims 1-4 wherein the one or more control instructions effect control over the particulate matter delivery control system.

8. A method according to any one of the preceding claims wherein the one or more parameters representative of real-time reactor subsystem output are derived from a selection of the following: a measure of relative prevalence of hydrogen gas in a gaseous mixture; a measure of purity of a hydrogen-based mixture; a quantity of hydrogen passing through a region as a function of time; a measure of fluidity in particles; a measure of conductivity in particles; a measure of graphite particle purity; a measure of the ratio of the primary particulate material relative to the conductive particulate material; and a temperature of a hydrogen-including output flow; a metric related to quantum of one or more particulate materials being released from the reactor subsystem as a function of time; a metric related to particle size of one or more particulate materials released from the reactor subsystem; a metric related to morphology of one or more particulate materials released from the reactor subsystem.

9. A method according to any one of the preceding claims wherein operating the control optimisation module additionally includes processing one or more parameters representative of real-time reactor subsystem input, including a hydrocarbon feed rate.

10. A method according to any one of the preceding claims wherein the one or more control instructions include a control instruction is representative of one or more of: (i) an instruction to adjust a rate of release of the primary particulate material into the reactor chamber; (ii) an instruction to release a defined quantity of the primary particulate material into the reactor chamber at a defined rate; (iii) an instruction to perform a batched delivery of a defined quantity of the primary particulate material into the reactor chamber at a defined time; (iv) and instruction of adjust a rate of pneumatic transport fluid for the primary particulate material; batch size for the primary particulate material; or (vi) batch frequency for the primary particulate material.

11. A method according to any one of the preceding claims wherein the one or more control instructions include an instruction which results in increasing or decreasing an amount of current and/or voltage being delivered through the one or more electrodes of the heating control system.

12. A method according to claim 11 wherein the instruction which results in increasing or decreasing an amount of current and/or voltage being delivered through the one or more electrodes of the heating control system is representative of a defined target temperature variation within the reactor chamber.

13. A method according to any one of the preceding claims wherein the one or more control instructions include an instruction to a processor which controls operating parameters of a fluidized bed reactor thereby to cause adjustment in relation to any one or more of heating, fluidization rate and/or pressure.

14. A method according to any one of the preceding claims wherein the reactor subsystem includes a reactor controller module, and wherein the operating a control module thereby to deliver the one or more control instructions includes providing signals to the reactor controller module, thereby to cause the reactor control module to operate in a defined manner.

15. A method according to claim 14 wherein causing the reactor control module to operate in a defined manner includes causing the reactor control module to: (i) increase or decrease heat in the reactor chamber; (ii) modify one or more fluidization parameters within the reactor chamber; or (iii) modify pressure within the reactor chamber.

16. A method according to any one of the preceding claims wherein the reactor subsystem includes a fluidized bed reactor.

17. A method according to any one of the preceding claims wherein the particulate matter delivery control system includes a quantity determination arrangement which is configured to measure a quantity of the primary particulate material prior to delivery to the reactor chamber.

18. A method according to claim 17 wherein the particulate matter delivery control system includes a particulate matter storage assembly coupled to a particulate matter delivery assembly, wherein the particulate matter delivery assembly includes a pre-delivery chamber which is configured to be selectively pressurised during delivery of the primary particulate material prior to delivery to the reactor chamber.

19. A method according to any one of the preceding claims wherein the control optimisation module to process data is additionally configured to process data from one or more further sources, including: (i) a sensor configured to monitor temperature within the reactor chamber; (ii) an input representative of a predicted future temperature within the reactor subsystem; (iii) an input representative of one or more parameters derived from monitoring of particulate matter detected in the reactor subsystem output; (iv) an input representative of one or more input gas delivery parameters; (v) an input representative of desired future operating conditions for the reactor subsystem; and (vi) an input representative of one or more parameters relating to gasses other than hydrogen detected in the reactor subsystem output.

20. A method according to any one of the preceding claims wherein the conductive particulate material includes one or more particulate materials is selected from the group comprising a graphitic starting material, a carbon material having encapsulated iron, iron ore, synthetic or naturally occurring iron oxide, or low quality iron oxide, preferably the electrically conductive material is selected from the group comprising a carbon material having encapsulated iron, iron ore, synthetic or naturally occurring iron oxide, or low quality iron oxide.

21. A method according to any one of the preceding claims wherein the primary particulate material includes a catalytic particulate material for hydrocarbon pyrolysis within the reactor subsystem.

22. A method according to any one of the preceding claims wherein the primary particulate material includes a material selected from the group comprising, a carbon material having encapsulated iron, iron ore, synthetic or naturally occurring iron oxide, or low quality iron oxide.

23. A method according to any one of the preceding claims wherein the primary particulate material includes a graphitic material.

24. A method according to claim 23 wherein the graphitic material selected from naturally occurring or synthetic graphite; flake graphite; and a form of electrically-conductive carbon.

25. A method according to any one of the preceding claims wherein the control optimisation module is responsive to the one or more parameters representative of reactor subsystem outputs and additionally inputs representative of desired future operation for generating the one or more control instructions.

26. A method according to claim 25 wherein the inputs representative of desired future operation include any one or more of: (i) desired hydrogen output parameters; (ii) desired output carbon parameters; and (iii) desired carbon output morphologies.

27. A system for controlling a hydrocarbon gas pyrolysis process, wherein the hydrocarbon gas pyrolysis process includes operation of a reactor subsystem having a reactor chamber in which a hydrocarbon gas is decomposed in presence of a conductive particulate material, the system comprising:
a data input module configured for receiving time series input data from a reactor output sensor system provided by the hydrocarbon gas pyrolysis system, wherein the reactor output sensor system is configured to monitor composition of a reactor output that is released from the reactor subsystem;
a processing module configured for processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
a control optimisation module operable to process data including the one or more parameters representative of real-time reactor subsystem output based on computer executable code, thereby to generate one or more control instructions; and
a control module operable thereby to deliver the one or more control instructions to effect control over at least one of: a heating control system, wherein the heating control system controls a level of current and/or voltage applied to one or more electrodes which are configured to deliver a current into the reactor chamber such that the current is propagated through the conductive particulate material; and
a particulate matter delivery control system, wherein the particulate matter delivery control system is configured to control metered delivery of a primary particulate material into the reactor chamber.

28. A system according to claim 27 wherein the one or more parameters relate to each of: (i) a measure of hydrogen gas in the reactor output; and (ii) a measure of the one or more particulate materials in the reactor output.

29. A system according to claim 27 wherein the one or more parameters relate to a measure of hydrogen gas in the reactor output.

30. A system according to claim 27 wherein the one or more parameters relate to a measure of one or more particulate materials in the reactor output.

31. A system according to any one of claims 27-30 wherein the one or more control instructions effect control over each of the heating control system and the particulate matter delivery control system.

32. A system according to any one of claims 27-30 wherein the one or more control instructions effect control over heating control system.

33. A system according to any one of claims 27-30 wherein the one or more control instructions effect control over the particulate matter delivery control system.

34. A system according to any one of claims 27-33 wherein the one or more parameters representative of real-time reactor subsystem output are derived from a selection of the following: a measure of relative prevalence of hydrogen gas in a gaseous mixture; a measure of purity of a hydrogen-based mixture; a quantity of hydrogen passing through a region as a function of time; a measure of fluidity in particles; a measure of conductivity in particles; a measure of graphite particle purity; a measure of the ratio of the primary particulate material relative to the conductive particulate material; and a temperature of a hydrogen-including output flow; a metric related to quantum of one or more particulate materials being released from the reactor subsystem as a function of time; a metric related to particle size of one or more particulate materials released from the reactor subsystem; a metric related to morphology of one or more particulate materials released from the reactor subsystem.

35. A system according to any one of claims 27-34 wherein operation of the control optimisation module additionally includes processing one or more parameters representative of real-time reactor subsystem input, including a hydrocarbon feed rate.

36. A system according to any one of claims 27-35 wherein the one or more control instructions include a control instruction is representative of one or more of: (i) an instruction to adjust a rate of release of the primary particulate material into the reactor chamber; (ii) an instruction to release a defined quantity of the primary particulate material into the reactor chamber at a defined rate; (iii) an instruction to perform a batched delivery of a defined quantity of the primary particulate material into the reactor chamber at a defined time; (iv) and instruction of adjust a rate of pneumatic transport fluid for the primary particulate material; batch size for the primary particulate material; or (vi) batch frequency for the primary particulate material.

37. A system according to any one of claims 27-36 wherein the one or more control instructions include an instruction which results in increasing or decreasing an amount of current and/or voltage being delivered through the one or more electrodes of the heating control system.

38. A system according to claim 37 wherein the instruction which results in increasing or decreasing an amount of current and/or voltage being delivered through the one or more electrodes of the heating control system is representative of a defined target temperature variation within the reactor chamber.

39. A system according to any one of claims 27-38 wherein the one or more control instructions include an instruction to a processor which controls operating parameters of a fluidized bed reactor thereby to cause adjustment in relation to any one or more of heating, fluidization rate and/or pressure.

40. A system according to any one of claims 27-39 wherein the reactor subsystem includes a reactor controller module, and wherein the operating a control module thereby to deliver the one or more control instructions includes providing signals to the reactor controller module, thereby to cause the reactor control module to operate in a defined manner.

41. A system according to any one of claims 27-40 wherein causing the reactor control module to operate in a defined manner includes causing the reactor control module to: (i) increase or decrease heat in the reactor chamber; (ii) modify one or more fluidization parameters within the reactor chamber; or (iii) modify pressure within the reactor chamber.

42. A system according to any one of claims 27-41 wherein the reactor subsystem includes a fluidized bed reactor.

43. A system according to any one of claims 27-42 wherein the particulate matter delivery control system includes a quantity determination arrangement which is configured to measure a quantity of the primary particulate material prior to delivery to the reactor chamber.

44. A system according to any one of claims 27-43 wherein the particulate matter delivery control system includes a particulate matter storage assembly coupled to a particulate matter delivery assembly, wherein the particulate matter delivery assembly includes a pre-delivery chamber which is configured to be selectively pressurised during delivery of the primary particulate material prior to delivery to the reactor chamber.

45. A system according to any one of claims 27-44 wherein the control optimisation module to process data is additionally configured to process data from one or more further sources, including: (i) a sensor configured to monitor temperature within the reactor chamber; (ii) an input representative of a predicted future temperature within the reactor subsystem; (iii) an input representative of one or more parameters derived from monitoring of particulate matter detected in the reactor subsystem output; (iv) an input representative of one or more input gas delivery parameters; (v) an input representative of desired future operating conditions for the reactor subsystem; and (vi) an input representative of one or more parameters relating to gasses other than hydrogen detected in the reactor subsystem output.

46. A system according to any one of claims 27-45 wherein the conductive particulate material includes one or more particulate materials is selected from the group comprising a graphitic starting material, a carbon material having encapsulated iron, iron ore, synthetic or naturally occurring iron oxide, or low quality iron oxide, preferably the electrically conductive material is selected from the group comprising a carbon material having encapsulated iron, iron ore, synthetic or naturally occurring iron oxide, or low quality iron oxide.

47. A system according to any one of claims 27-46 wherein the primary particulate material includes a catalytic particulate material for hydrocarbon pyrolysis within the reactor subsystem.

48. A system according to any one of claims 27-47 wherein the primary particulate material includes a material selected from the group comprising, a carbon material having encapsulated iron, iron ore, synthetic or naturally occurring iron oxide, or low quality iron oxide.

49. A system according to any one of claims 27-48 wherein the primary particulate material includes a graphitic material.

50. A system according to claim 49 wherein the graphitic material selected from naturally occurring or synthetic graphite; flake graphite; and a form of electrically-conductive carbon.

51. A system according to any one of claims 27-50 the control optimisation module is responsive to the one or more parameters representative of reactor subsystem outputs and additionally inputs representative of desired future operation for generating the one or more control instructions.

52. A system according to claim 51 wherein the inputs representative of desired future operation include any one or more of: (i) desired hydrogen output parameters; (ii) desired output carbon parameters; and (iii) desired carbon output morphologies.

53. A method for controlling a hydrocarbon gas pyrolysis system, wherein the hydrocarbon gas pyrolysis system includes a reactor subsystem having a reactor chamber in which a hydrocarbon gas is decomposed in presence of a conductive particulate material, the method comprising:
receiving time series input data from a reactor output sensor system provided by the hydrocarbon gas pyrolysis system, wherein the reactor output sensor system is configured to monitor composition of a reactor output that is released from the reactor subsystem;
processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
operating a control optimisation module to process data including the one or more parameters representative of real-time reactor subsystem output based on computer executable code, thereby to generate one or more control instructions; and
operating a control module thereby to deliver the one or more control instructions to effect control over at least one of: a heating control system, wherein the heating control system controls a temperature in the reactor chamber; and a particulate matter delivery control system, wherein the particulate matter delivery control system is configured to control metered delivery of a primary particulate material into the reactor chamber.

54. A system for controlling a hydrocarbon gas pyrolysis system, wherein the hydrocarbon gas pyrolysis system includes a reactor subsystem having a reactor chamber in which a hydrocarbon gas is decomposed in presence of a conductive particulate material, the method comprising:
a data input module configured for receiving time series input data from a reactor output sensor system provided by the hydrocarbon gas pyrolysis system, wherein the reactor output sensor system is configured to monitor composition of a reactor output that is released from the reactor subsystem;
a processing module configured for processing the time series input data thereby to determine one or more parameters representative of real-time reactor subsystem output, wherein the one or more parameters representative of real-time reactor subsystem output relate to either or both of: (i) a measure of hydrogen gas in the reactor output; and (ii) a measure of particulate material in the reactor output;
a control optimisation module operable to process data including the one or more parameters representative of real-time reactor subsystem output based on computer executable code, thereby to generate one or more control instructions; and
a control module operable thereby to deliver the one or more control instructions to effect control over at least one of: a heating control system, wherein the heating control system controls a temperature in the reactor chamber; and a particulate matter delivery control system, wherein the particulate matter delivery control system is configured to control metered delivery of a primary particulate material into the reactor chamber.
